(19) United States
(12) Patent Application Publication
(10) Pub. No.: US 2006/0285523 A1
(43) Pub. Date: Dec. 21, 2006

(54) Resource relocation method, base station, and radio network control device

(75) Inventors: Hidenori Ishii, Tokyo (JP); Toshiaki Nagasawa, Sagamihara-shi (JP); Kenji Takagi, Yokohama-shi (JP); Go Nakano, Shibuya-ku (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 10/556,379

(22) PCT Filed: May 12, 2004
(86) PCT No.: PCT/JP04/06669

§ 371 Date: Dec. 28, 2005

(30) Foreign Application Priority Data
May 14, 2003 (JP) 2003-135818
Jun. 27, 2003 (JP) 2003-184160

(51) Int. Cl. H04B 7/216

(52) U.S. Cl. 370/335; 370/342

(57) ABSTRACT

Based on traffic that includes a plurality of types of calls and varies with time, resources are located efficiently in a base transceiver station that has a plurality of cards that perform baseband signal processing, and prevention of the occurrence of call loss is contrived. There are provided signal processing cards that perform baseband signal processing and so forth, a radio resource monitoring section that monitors the state of signal processing cards, a radio resource control section that performs signal processing card resource allocation and shifting, and a traffic recording section that records the traffic generated in different time periods; and call loss when accommodating a most frequently generated call in each time period can be prevented by, as far as possible, determining a threshold value for the number of vacant resources from the call that is to be accommodated, activating relocation processing when the number of vacant resources in the base transceiver station becomes lower than the threshold value, and varying the threshold value based on the number of required resources of the most frequently generated calls in each time period.

### TECHNICAL FIELD

The present invention relates to a resource management method whereby, in a radio network apparatus that accommodates terminals that perform radio communication, resources in the apparatus are allocated appropriately to each terminal.

### BACKGROUND ART

The popularity of mobile phones has grown remarkably in recent years, and the first W-CDMA (Wideband Code Division Multiple Access) standard mobile phone service was started in Japan in 2001. With regard to communication technology, digital mobile phones handled only voice and low-speed packet communications, but the introduction of W-CDMA has made wideband transmission possible, with 384 kbps service beginning as of 2002.

A W-CDMA network is composed of a switching system (switch), RNC (Radio Network Controller), BTS (Base Transceiver Station), and so forth. Of these, the base transceiver station performs radio communication with a mobile phone terminal, and converts radio signals for network use.

With W-CDMA, various applications are offered to make use of wideband transmission, and therefore the kind of traffic generated within the coverage area of a base transceiver station has seen an increase in high-speed transmission calls such as TV conference and high-speed packet transmission.

Along with this, there is a demand for the capacity of base transceiver stations to be used effectively through improvement of the resource management scheme. A “resource” according to the present invention basically refers to processing capability necessary for baseband processing in a base transceiver station, and is a different concept from a radio resource indicating the radio wave strength of individual channels and so forth.

First, an example of a prior-art configuration relating to a resource relocation scheme is shown in FIG. 1.

In FIG. 1, reference code 11 denotes a terminal. In subsequent descriptions a terminal is assumed to be a W-CDMA or MC-CDMA (Multi-Carrier CDMA) third-generation mobile phone, but the present invention can also be applied to a GSM (Global System for Mobile communications), PHS (Personal Handy-phone System), PDC (Personal Digital Cellular), or other mobile phone or cordless phone.

Reference code 12 denotes a base transceiver station that accommodates terminal 11, performs radio signal transmission/reception to/from terminal 11, and converts radio signals to cable signals. Reference code 13 denotes a network that has a switching function. Network 13 is connected to base transceiver station 12 via a dedicated line and ATM (Asynchronous Transfer Mode).

Reference codes 14 through 19 denote internal components of the base transceiver station.

Reference code 14 denotes a radio communication section that performs radio signal transmission/reception to/from terminal 11. Radio communication section 14 transmits and receives radio signals by means of an antenna, and performs transmission power control of terminal 11, frequency modulation processing, and so forth. Radio communication section 14 is equipped with an antenna, an amplifier, a transmission power source, and a control program.

Reference code 15 denotes a connection control section that controls connection/disconnection of the communication path for terminal 11 in accordance with requests from network 13. Connection control section 15 is implemented as a program in a control card of base transceiver station 12.

Reference code 16 denotes a signal processing section that performs signal processing on a radio signal from terminal 11, such as baseband modulation processing and conversion to a cable signal. In order for many terminals 11 to be accommodated by base transceiver station 12 simultaneously, signal processing section 16 is equipped with many cards of the same format; these cards will be referred to as first signal processing card 16a through nth signal processing card 16c.

Reference code 17 denotes a radio resource control section that performs allocation/deallocation of a generated call to/from a signal processing card in signal processing section 16.

Reference code 18 denotes a cable communication section that performs signal transmission/reception to/from network 13.

Reference code 19 denotes a call type priority determination section that determines priority for each call type from the probability of receiving call for each call type (incoming call probability) and from communication quality of each call type.

Base transceiver station 12 accommodates calls of terminal 11. The processing capability of first through nth signal processing cards 16a through 16c that perform call signal processing at this time is referred to as “the number of accommodated resources,” and processing that allocates a call to a signal processing card when a call is generated is referred to as “resource allocation processing.”

The performance of signal processing cards depends on hardware, and, while there are various values, it is here assumed that each signal processing card has 768 kbps signal processing capability. Also, one resource is defined as 24 kbps signal processing capability. Thus, the number of accommodated resources of each signal processing card is 32. It is also assumed that base transceiver station 12 supports the following types of calls.

(a) Voice call 1 resource

(b) Unrestricted digital call (64 kbps) 3 resources

(c) Packet A call (128 kbps) 6 resources

(d) Packet B call (384 kbps) 16 resources

(e) Common channel 8 resources

Item (e), common channel, is a channel for controlling all terminals, and may be a BCH (Broadcast Channel), FACH (Forward Access Channel), PCH (Paging Channel), RACH (Random Access Channel), or the like. The number of required resources for a common channel increases or decreases according to the size of the coverage area and number of accommodated channels of a base transceiver station, but is here assumed to be eight.

With W-CDMA, many kinds of call service are possible, such as voice calls, packet calls, and unrestricted digital calls. The transmission speed and the number of resources necessary for a signal processing card to process a call differ according to the type of call.

In resource allocation processing there are two requirements in an environment in which many such types of calls requiring different numbers of resources are repeatedly generated and terminated: that the limited base transceiver station resources be used effectively to prevent call loss as far as possible, and that the load be distributed among a plurality of signal processing cards to reduce the load on individual signal processing cards.

A defect of resource allocation processing is that, when the amount of traffic flowing into a base transceiver station is large under the two conditions postulated below, small amounts of vacant resources are distributed to a plurality of signal processing cards (such condition will be referred to as “vacant resource fragmentation”), and efficiency deteriorates.

(A1) A communication scheme such as W-CDMA is used in which there are many types of calls, and the number of required resources differs according to the type of call.

(A2) There is a restriction to the effect that one call must be allocated to one signal processing card.

Particularly in the case of a restriction stipulating that one call must always be allocated to one signal processing card, as in (A2), even if the total number of vacant resources of all the cards in a base transceiver station exceeds the number of required resources for a newly generated call, call allocation may not be possible because the number of vacant resources per card is less than the number of required resources.

For example, if the number of vacant resources of two of the signal processing cards in a base transceiver station is 4, and the number of vacant resources of the other signal processing cards is 0, the number of vacant resources per card is less than the number of required resources for a packet A call, which is 6. Therefore, a packet A call cannot be allocated in this case even though the overall number of vacant resources in the base transceiver station is 4×2=8.

Thus, in order to improve efficiency of resource utilization, a countermeasure against restriction (A2) is necessary. The following two countermeasures can be considered.

(C1) Eliminate restriction (A2) by adding functions for synchronization and liaison between a plurality of signal processing cards to the signal processing cards themselves.

(C2) Change some call allocation destination signal processing cards, and gather a plurality of small-scale vacant resources together in one place (hereinafter referred to as “resource relocation”).

First, (C1) will be described. Carrying out design so that signal processing of one call is performed simultaneously by a plurality of signal processing cards (LSIs, cards, and so forth) involves high costs, since it is necessary to implement functions for synchronization and liaison among a plurality of signal processing cards and so forth. Especially when there are many baseband processing devices or cards corresponding to the signal processing cards according to the description of the present invention in a base transceiver station, the cost increase will greatly affect the overall cost of the base transceiver station, and therefore a scheme other than one that avoids the restriction in (A2) by improving the functions of the signal processing cards is desirable.

The method in (C2) is disclosed from page 12 onward of Unexamined Japanese Patent Publication No. 2002-505065 (hereinafter referred to as “Patent Document 1”). Patent Document 1 mainly shows an allocation scheme for an FDMA (Frequency DMA)/TDMA (Time DMA) system, and shows an algorithm for a case where a service spans a plurality of frequencies or time periods.

In Patent Document 1, priority is determined for each call type using total incoming call probability, taking the inclusion relationship between a plurality of call types into consideration, and when there are not sufficient vacant resources in a card to which a call is allocated, the number of vacant resources is increased by disconnecting a call of lower priority than a new call, and then accommodation of a higher-priority call will be performed. In Patent Document 1, in particular, it is considered that a call of a type requiring a larger number of resources includes a call of a type requiring a smaller number of resources, total incoming call probability for each call type is calculated by totaling the incoming call probabilities of the included calls, and the higher the total incoming call probability, the higher is the call type priority. Thus, for a call type for which the number of required resources is small, the number of call types included is small and the total incoming call probability is low, and therefore priority is low, while priority is high for a call type for which the number of required resources is large.

An algorithm that performs allocation based on priority calculated using total in coming call probability, applied to W-CDMA, is shown below.

(P1) A call is generated.

(P2) Call type priority determination section 19 determines the call type priority according to the call type (outgoing/incoming, incoming call probability, etc.).

(P3) The generated call is allocated to one signal processing card 16.

(P4) After allocation is complete, an area of a vacancy with the same amount of resources as a call of the maximum number of resources among calls generated thus far is searched for, and, if there is no such vacancy, a low-priority call is disconnected to create a vacancy.

By this means, a high-priority call, or a call generated later, can be accommodated.

However, a problem with Patent Document 1 is a lack of convenience in that, since a low-priority call is disconnected when fragmentation occurs and a relocation destination cannot be found in relocation processing, disconnection of a low-priority call occurs in the event of call fragmentation on the base transceiver station side even when radio wave conditions between a terminal and base transceiver station are good. Since there are various possible kinds of communication modes in W-CDMA, in particular, more calls occupying resources for a long period are generated, and there are more types of calls than in the case of GSM or PDC, making fragmentation more prone to occur.

Also, in order to shift a call between signal processing cards in relocation processing without disconnecting the call, pre-shift and post-shift resources are secured simultaneously. Therefore, a call consumes twice as many resources as normal while signal processing synchronization is being performed. Moreover, in relocation processing, the operational load due to processing for searching for a call to be shifted and a signal processing card to be shifted to is greater than in normal processing.

In Patent Document 1, call priority assignment is performed based on the total of the incoming call probabilities of the various types, but since a call for which the number of required resources is comparatively large consequently has higher priority, the relocation processing threshold value is also determined based on that number of resources. However, in a situation in which voice calls for which the number of required resources is small account for a high percentage of total traffic, call loss due to fragmentation of vacant resources is unlikely to occur even if relocation processing is not performed. In such a case, also, there is a possibility of unnecessary relocation processing being performed because the Patent Document 1 algorithm sets the threshold value to a value greater than the voice call value.

On the other hand, depending on the way calls are generated, there is a possibility of the load being concentrated on some signal processing cards even when the traffic volume is small. In order to improve efficiency in resource utilization by preventing fragment of vacant resources, it is desirable to concentrate calls on one card even when traffic volume is low. However, when allocation is performed using this method, since calls are concentrated in some of the signal processing cards even when the level of traffic is low, and the processing capability of those signal processing cards continues being almost fully used, a corresponding performance margin must be provided in signal processing card design. Thus, by equalizing the amount of processing per signal processing card, it is possible to provide a margin in signal processing card processing capability thereby achieving longer life, reducing maintenance costs, and leading to lower card cost by reducing the design margin.

On the other hand, conventional inventions relating to resource allocation processing for load distribution include Unexamined Japanese Patent Publication N0.2001-119752 (hereinafter referred to as “Patent Document 2”). From page 4 onward, Patent Document 2 shows a load distribution scheme in a radio communication apparatus equipped with a plurality of system LSIs for baseband signal processing. Here, a case is shown in which this is applied to a scheme whereby load distribution is performed among signal processing cards.

In Patent Document 2, distributing the load among a plurality of signal processing cards reduces the average amount of processing for each individual signal processing card, and makes it possible to lower the costs necessary for signal processing card implementation. Also, while concentrating processing in one place means that failure of the relevant signal processing card has a major effect, performing load distribution enables damage in the event of a failure to be mitigated. A description of Patent Document 2 will be described below using FIG. 1 in the same way as for Patent Document 1.

According to Patent Document 2, load distribution is achieved by performing resource allocation using the following procedure.

(D1) After a call arrives, an estimate is made of the number of resources required for processing of that call.

(D2) The call is allocated to the signal processing card that has the smallest number of resources in use among signal processing cards in which the number of resources estimated in (D1) are vacant.

For example, if a call is not accommodated in a base transceiver station that has three or more signal processing cards, as shown in FIG. 1, allocation is performed as described below when three voice calls with a number of required resources of 1 are generated in succession.

In allocation of the first voice call, since no call has been allocated to any card, the first voice call is allocated to the lowest-numbered card—that is, the first signal processing card.

In the case of the next voice call, since calls have not been allocated to any signal processing cards other than the first signal processing card, the call is allocated to the lowest-numbered of these other cards—that is, the second signal processing card.

In the case of the third voice call, since calls have not been allocated to any signal processing cards other than the first and second signal processing cards, the call is allocated to the lowest-numbered of these signal processing cards to which calls have not been allocated.

In Patent Document 2, resource allocation is successively performed for each newly generated call (hereinafter referred to as “new call”) to the signal processing card that has the smallest number of resources in use.

However, while Patent Document 1 and Patent Document 2 assume a case in which resources are divided among individual signal processing cards, there are actually cases where a plurality of signal processing hardware units (hereinafter referred to as “units”) are installed inside a card. In such a case, a single call cannot be processed simultaneously by a plurality of units on a load-sharing basis in the same way as with signal processing cards.

In this case, the following two problems will arise if a threshold value is determined by the number of vacant resources of each card, and whether or not relocation processing is possible is determined by the number of vacant resources.

(A) If vacant resources are distributed among a plurality of units, relocation processing will not be activated and call loss will occur.

(B) There is a possibility of vacant resources being distributed to a plurality of units in the same card as a result of relocation, and call loss occurring.

To give only an example relating to (A), assume for example that the threshold value is set to 16 vacant resources in order to facilitate packet B call accommodation.

At this time, a packet B call cannot be allocated to a signal processing card with eight vacant resources in each of two units, but since the number of vacant resources of the entire card is 16, relocation processing is not activated, and the packet B call remains unaccommodated.

On the other hand, Patent Document 2 shows a scheme of resource allocation at the time of call generation. Since the allocation scheme enables an optimal allocation location to be specified only when the number of vacant resources in the entire base transceiver station is sufficient, this scheme has the effect of equalizing the number of resources used among a plurality of cards when traffic increases from a low level. However, when a call is disconnected and deallocated, the call that is disconnected and deallocated cannot be selected by the allocation scheme. There are consequently the following problems when traffic declines after traffic temporarily increases and almost all the signal processing card resources are used.

It is not possible to equalize the number of resources used among a plurality of cards.

There is a possibility that a call for which the number of required resources is small, such as a voice call, will remain in a plurality of cards, and it will not be possible to perform allocation of a call for which the number of required resources is large at the time of allocation.

### DISCLOSURE OF INVENTION

The present invention has been implemented taking into account the problems described above, and it is therefore an object of the present invention to achieve more efficient resource allocation by executing resource relocation processing without disconnecting an existing call.

According to one aspect of the present invention, a resource relocation method in a base transceiver station that allocates a plurality of types of calls with different numbers of resources to a plurality of signal processing cards sets a threshold value relating to the number of vacant resources in each signal processing card as corresponding to an individual time period based on the number of resources of a call that has the maximum generation ratio in each of a plurality of predetermined time periods; and when the respective numbers of vacant resources in a predetermined number of signal processing cards among the aforementioned plurality of signal processing cards falls to or below the threshold value, performs relocation processing of a call already accommodated in the aforementioned plurality of signal processing cards.

According to another aspect of the present invention, a base transceiver station that allocates a plurality of types of calls with different numbers of resources to a plurality of signal processing cards has a radio resource monitoring section that sets a threshold value relating to the number of vacant resources in each signal processing card as corresponding to an individual time period based on the number of resources of a call that has the maximum generation ratio in each of a plurality of predetermined time periods; and a radio resource control section that, when the respective numbers of vacant resources in a predetermined number of signal processing cards among the aforementioned plurality of signal processing cards falls to or below the threshold value, performs relocation processing of a call already accommodated in the aforementioned plurality of signal processing cards.

### BRIEF DESCRIPTION OF DRAWINGS

FIG. 1 is a configuration diagram of a base transceiver station according to the prior art;

FIG. 2 is a configuration diagram of a base transceiver station according to a first embodiment of the present invention;

FIG. 3 is a state diagram of a signal processing section according to the first embodiment of the present invention;

FIG. 4 is a drawing of the management table in a radio resource control section according to the first embodiment of the present invention;

FIG. 5 is a schematic diagram of processing of a signal processing section according to the first embodiment of the present invention;

FIG. 6 is a flowchart of relocation processing according to the first embodiment of the present invention;

FIG. 7 is a configuration diagram of a traffic recording section according to the first embodiment of the present invention;

FIG. 8A is a drawing showing an example of a shift call list according to the first embodiment of the present invention;

FIG. 8B is a drawing showing another example of a shift call list according to the first embodiment of the present invention;

FIG. 9 is a configuration diagram of a system according to a second embodiment of the present invention;

FIG. 10 is a state diagram of resources in a base transceiver station according to the second embodiment of the present invention;

FIG. 11 is a configuration diagram of a base transceiver station according to a third embodiment of the present invention;

FIG. 12 is a state diagram of a signal processing section according to the third embodiment of the present invention;

FIG. 13 is a flowchart of relocation processing according to the third embodiment of the present invention;

FIG. 14 is a field diagram of a shift destination determined call list according to the third embodiment of the present invention;

FIG. 15 is a flowchart of relocation processing according to a fourth embodiment of the present invention;

FIG. 16 is a state diagram (1) of a signal processing section according to the fourth embodiment of the present invention; and

FIG. 17 is a state diagram (2) of a signal processing section according to the fourth embodiment of the present invention.

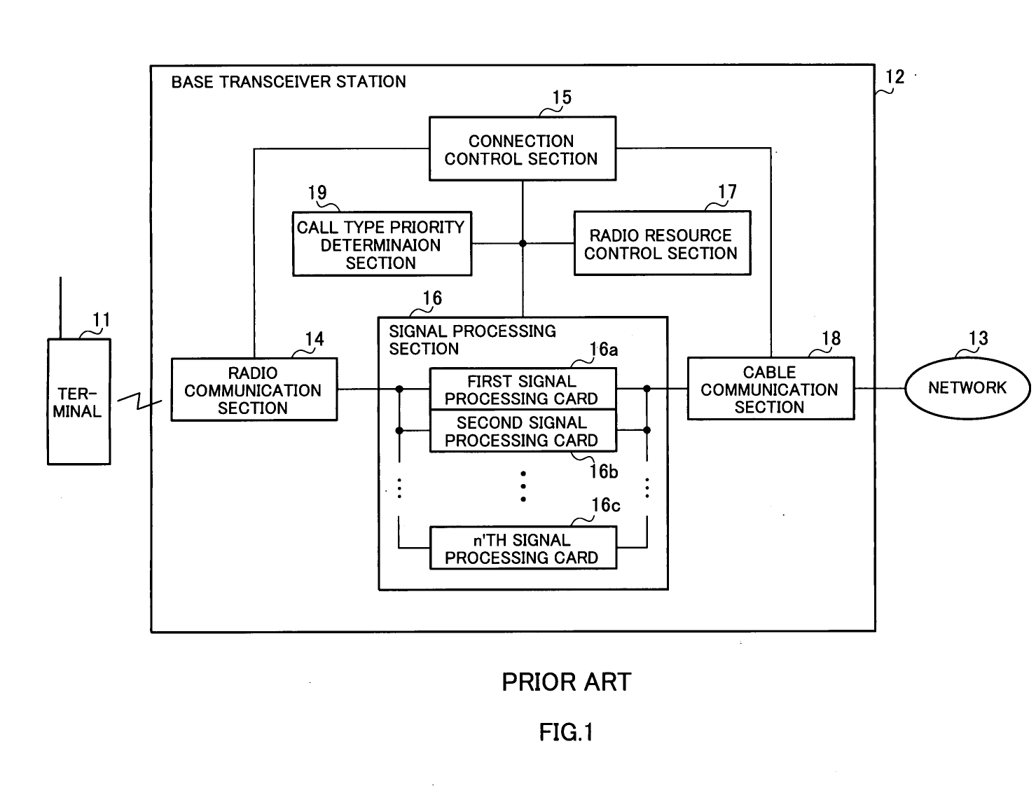

### BEST MODE FOR CARRYING OUT THE INVENTION

With reference now to the accompanying drawings, embodiments of the present invention will be explained in detail below.

### Embodiment 1

This embodiment is an efficient resource relocation scheme in a W-CDMA system in which resource hold times and required numbers of resources vary greatly. When a plurality of types of calls for which the required numbers of resources vary are accommodated in a base transceiver station using a plurality of signal processing cards, it may not be possible to accommodate a call for which the number of required resources is large in a signal processing card to which a call has already been allocated. In contrast, with the present invention, call loss is reduced and signal processing card capacity is utilized effectively by determining a threshold value according to the number of resources of a call to be accommodated, and, when vacant resources equivalent to the threshold value are no longer present in any signal processing card, performing call relocation so that a call with as large a number of required resources as possible can be accommodated.

In this embodiment, a section is provided that performs recording of traffic within a base transceiver station, and, by changing relocation processing activation conditions according to changes over time in the proportions of voice calls and packet calls, it is possible to perform relocation processing to more dependably accommodate calls of which many are generated in each time period. For example, when there are a large number of calls for which the number of required resources is 1, the call loss rate due to fragmentation decreases, and therefore setting a low threshold value for the number of vacant resources for initiating relocation processing in such a time period reduces the number of times response processing is activated, suppresses the number of additionally consumed resources due to call shift processing in relocation processing, and reduces the operational load of the base transceiver station.

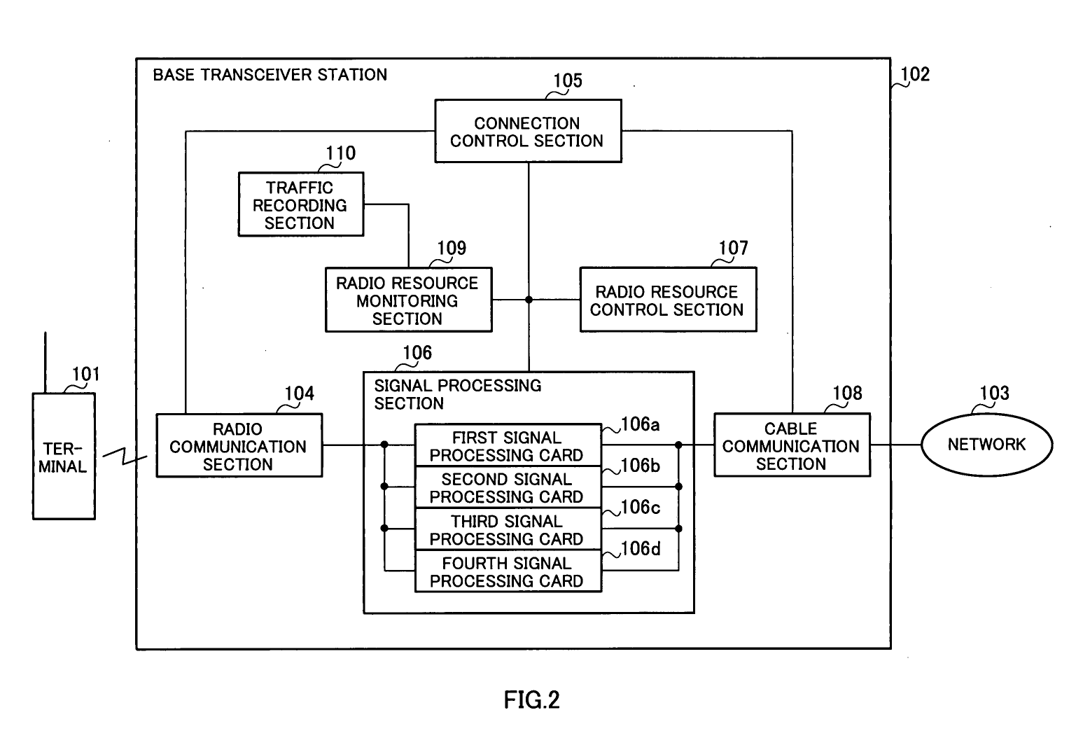

This first embodiment of the present invention will now be described. FIG. 2 shows a block configuration diagram of the present invention. In FIG. 2, reference codes 101 through 108 correspond to reference codes 11 through 18 in the example of the prior art.

In FIG. 2, reference code 101 denotes a terminal. In subsequent descriptions a terminal is assumed to be a W-CDMA (Wideband Code Division Multiple Access) or MC-CDMA (Multi-Carrier CDMA) third-generation mobile phone, but the present invention can also be applied to a GSM (Global System for Mobile communications), PHS (Personal Handy-phone System), PDC (Personal Digital Cellular), or other mobile phone or cordless phone.

Reference code 102 denotes a base transceiver station that accommodates terminals, performs radio signal transmission/reception to/from terminals, and converts radio signals to cable signals.

Reference code 103 denotes a network that has a switching function. Network 103 is connected to the base transceiver station via a dedicated line and ATM (Asynchronous Transfer Mode).

Reference codes 104 through 110 denote internal components of the base transceiver station.

Reference code 104 denotes a radio communication section that performs radio signal transmission/reception to/from terminal 101. Radio communication section 104 performs radio signal transmission/reception by means of an antenna, transmission power control of the terminal, frequency modulation processing, and so forth. Radio communication section 104 is equipped with an antenna, an amplifier, a transmission power source, and a control program.

Reference code 105 denotes a connection control section that controls connection/disconnection of communication paths for terminals in accordance with requests from network 103. The connection control section is implemented as a program in a control card of the base transceiver station.

Reference code 106 denotes a signal processing section that performs signal processing on a radio signal from a terminal, such as baseband modulation/demodulation processing and conversion to a cable signal. In order for many terminals to be accommodated by the base transceiver station simultaneously, the signal processing section has a configuration equipped with many cards and LSIs of the same format, and hardware units comprising combinations thereof. In this embodiment it is assumed that the base transceiver station is equipped with four sets of the same kind of hardware, designated first signal processing card 106a through fourth signal processing card 106d.

Reference code 107 denotes a radio resource control section that performs allocation/deallocation of a generated call to/from a signal processing card in signal processing section 106.

Reference code 108 denotes a cable communication section that performs signal transmission/reception to/from network 103.

Reference code 109 denotes a radio resource monitoring section that performs monitoring of the state of the signal processing section and determines whether or not call relocation is necessary, and, when call relocation is necessary, issues a call relocation directive to the radio resource control section.

Reference code 110 denotes a traffic recording section that records the generation time, type, and hold time, of a call accommodated by base transceiver station 102 based on data of radio resource monitoring section 109.

In this embodiment, a method is shown whereby call relocation contents are changed according to the contents of traffic recording section 110.

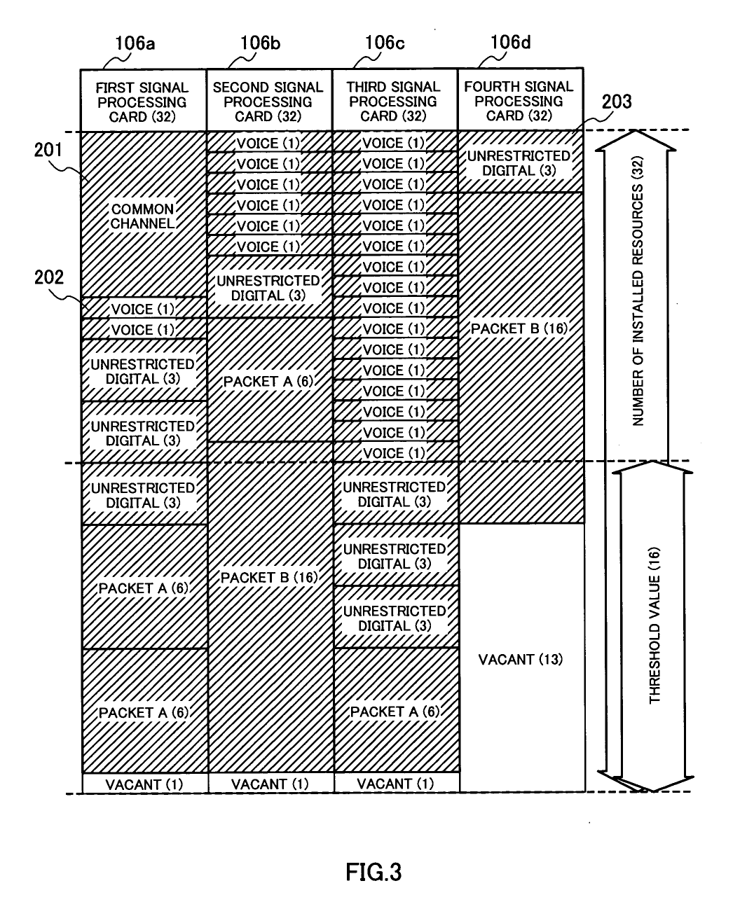

Next, FIG. 3 will be explained.

FIG. 3 shows the call accommodation state of signal processing section 106.

The number of signal processing cards inside signal processing section 106 is assumed to be 4, and, as in the prior art, each signal processing card has 768 kbps signal processing capability, one resource is defined as 24 kbps signal processing capability, and the base transceiver station supports the following types of calls.

(a) Voice call (24 kbps) 1 resource
(b) Unrestricted digital call (64 kbps) 3 resources
(c) Packet A call (128 kbps) 6 resources
(d) Packet B call (384 kbps) 16 resources
(e) Common channel (192 kbps ) 8 resources

The types of calls supported differ according to the communication provider providing communication services.

With regard to the resource unit, speed increases or decreases according to the hardware of the base transceiver station, and the speed unit may also be sps (Symbols Per Second) or the like. With the present invention, the same kind of effect can be achieved even if the number of signal processing cards in the signal processing section, the signal processing card processing capability, and/or the resource unit vary on a card-by-card basis.

Also, in this embodiment, it is assumed that resources corresponding to one call need not be continuous within a signal processing card. For example, when voice call 202 is deallocated from the state in FIG. 3, it may be regarded that there are two separate item each of which consists one vacant resource, or it may be regarded that there is just one item which consists two vacant resources.

The states of first signal processing card 106a in FIG. 3 will now be explained. First signal processing card 106a accommodates a common channel, two voice calls, three unrestricted digital calls, and two packet A calls. The number in parentheses after the name of each field indicates the size of the area converted to a number of resources. As the number of installed resources of a signal processing card is 32, and a common channel accounts for 8, a voice call for 1, an unrestricted digital call for 3, and a packet A call for 6, the number of vacant resources is (32−8−1×2−3×3−6×2=) 1. Accommodated calls are shown in the same way for second signal processing card 106b through fourth signal processing card 106d.

In this embodiment, the locations in which calls are accommodated in the same processing card are immaterial. Therefore, it is only necessary to ascertain the number of vacant resources in the management table in the radio resource control section.

When processing capability differs according to the card, it is necessary to manage not only the number of vacant resources but also the number of resources installed in each card, but the effect of the present invention is similarly obtained in this case also.

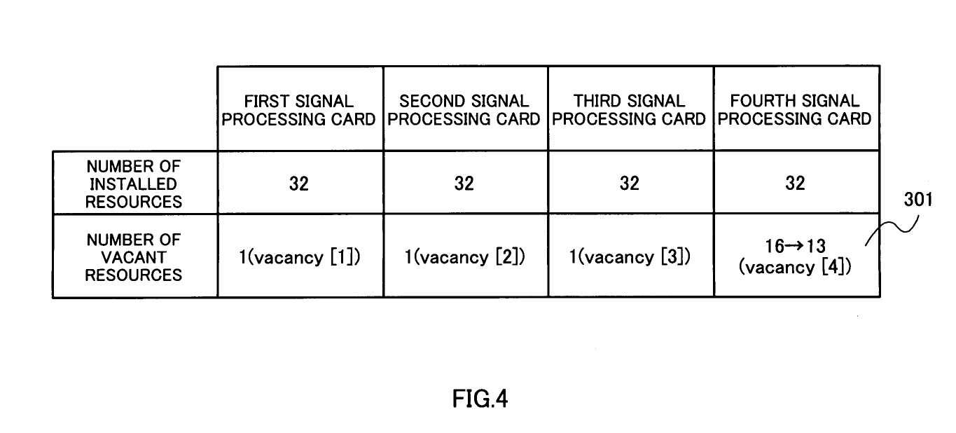

FIG. 4 shows the contents of the signal processing section 106 management table held by radio resource control section 107. The management table holds the number of vacant resources of all signal processing cards at each point in time. Vacancies in first signal processing card 106a through fourth signal processing card 106d are hereinafter referred to as “vacancy [1]” through “vacancy [4].” To take the example of first signal processing card 106a, the number of vacant resources (vacancy [1]) is 1.

When the number of installed resources differs according to the signal processing card, the effect of the present invention can be achieved if not only the number of resources used but also the number of resources installed in each card are managed.

A description will first be given of call processing up to when base transceiver station 102 reaches the state in FIG. 3 from a state in which resources have not been allocated at all immediately after startup.

When base transceiver station 102 starts up, a common channel used for terminal 101 calling and so forth is secured. Assuming that call allocation to signal processing cards is performed in low-to-high number order for the common channel, radio resource allocation section 104 allocates resources that process the common channel to first signal processing card 106a. This is the common channel 201 portion in FIG. 3.

Apart from using low-to-high card number order, other possible methods of determining the allocation destination signal processing card are to perform allocation in high-to-low number order, to start allocation from the signal processing card with the smallest number of vacant resources among all the signal processing cards, or to start allocation from the signal processing card with the largest number of vacant resources among all the signal processing cards. The effect of the present invention can be achieved with any of these methods.

When base transceiver station 102 finishes securement of the common channel, terminal 101 performs location registration and ATTACH processing (processing that places the terminal in a state in which call termination from the network is possible) with respect to network 103. Although resources are actually also used in terminal ATTACH processing, it is possible to obtain the effect of the present invention in this case also. However, to simplify the description, resources used in ATTACH processing are not considered in this embodiment.

After location registration, when terminal 101 originates a voice call, base transceiver station 102 establishes a communication path to be used for a call between terminal 101 and network 103, and allocates the voice call to a signal processing card 106. This is voice call 202 in FIG. 3.

The resource allocation procedure when terminal 101 originates a call will now be described in detail. The resource allocation procedure is also similar for other kinds of call.

First, terminal 101 outputs an origination request to network 103 via base transceiver station 102 through the common channel. On receiving this request, radio communication section 104 in base transceiver station 102 first executes demodulation processing and so forth, and outputs the request to first signal processing card 106a allocated to the common channel in signal processing section 106. First signal processing card 106a performs baseband processing and conversion to a cable signal, and outputs the origination request to cable communication section 108. Cable communication section 108 performs protocol conversion of a signal of the origination request to ATM or the like, and outputs the request to network 103. In this embodiment, base transceiver station 102 is controlled only by network 103, and is not controlled by a signal from a terminal.

As the algorithm of the present invention is not related to a resource allocation processing trigger, it is possible for the effect of the present invention to be similarly achieved when resource allocation processing is controlled by a terminal signal.

In response to the origination request, network 103 outputs a voice call resource securement request for terminal 101 to base transceiver station 102. Base transceiver station 102 allocates the call to a suitable signal processing card in accordance with the resource securement request.

The procedure whereby base transceiver station 102 allocates resources in accordance with the resource securement request from network 103 will now be described in detail. First, the resource securement request from network 103 is input to cable communication section 108. Since this resource securement request is a control request for base transceiver station 102, it is detected by connection control section 105. Connection control section 105 outputs to radio resource control section 107 a request to secure resources for a voice call in signal processing section 106. Radio resource control section 107 references the management table in signal processing section 106, and, since there is a vacancy in first signal processing card 106a, the voice call is allocated here. This allocated call is voice call 202 in FIG. 3. Radio resource control section 107 also decreases the number of vacant resources in its internal management table in accordance with the number of allocated resources.

After resource allocation has been performed, connection control section 105 sets a communication path so that a voice call signal from terminal 101 is able to be output appropriately to network 103 by means of radio communication section 104, signal processing section 106 (first signal processing card 106a), and cable communication section 108, and outputs a response to the resource securement request to network 103 via cable communication section 108. By this means, a communication path from terminal 101 to network 103 is established. Thereafter, communication with the terminal 101 calling destination is started by means of upper layer call control, but this is not directly related to the present invention and therefore a description thereof is omitted here.

In addition to voice calls, FIG. 3 includes unrestricted digital calls, and packet calls such as packet A and packet B calls. Resource allocation processing is performed in the same way for these calls, except for differences in the number of required resources.

When a call ends, following upper layer call disconnection processing, a resource release request containing a designation of the call to be deallocated is output from network 103 to base transceiver station 102. On detecting this request, connection control section 105 outputs a request to release resources to radio resource control section 107. Radio resource control section 107 specifies the signal processing card subject to the release, and has signal processing section 106 deallocate the relevant call. The number of vacant resources of the relevant signal processing card is also incremented in the management table in radio resource control section 107.

In this embodiment, a low-to-high signal processing card number order is used as the allocation order, but, in FIG. 3, there is a vacancy in the first signal processing card. The reason for this is that, since the call connection time varies greatly depending on the call, after allocation to a high-numbered signal processing card, a call allocated to a low-numbered signal processing card ends, and corresponding resources become vacant.

This concludes an overview of call processing up to the state in FIG. 3.

Next, a description will be given of relocation processing according to the present invention.

With the present invention, in order to accommodate a call for which the number of required resources is large in any signal processing card, a vacant resource number threshold value (hereinafter referred to as “resource threshold”) is determined from the required resources of a call to be accommodated, and vacant resources equivalent to that threshold value are secured.

In this embodiment, traffic is recorded and a threshold value is determined according to the results.

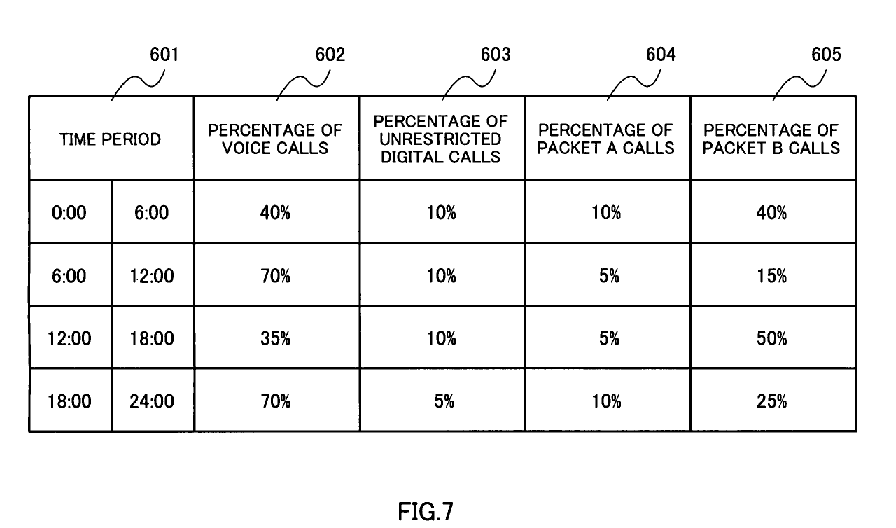

First, the traffic recording section data shown in FIG. 7 will be explained.

In this embodiment, a method is shown whereby a base transceiver station changes calls that have priority for accommodation according to the frequency of generation of each type of call in each time period.

In FIG. 7, reference code 601 denotes a time period. For example, when 0:00 and 6:00 are specified, this indicates the period from 0:00 to 6:00. In this embodiment, an example is shown in which a day is divided into 6-hour periods, but the same kind of effect as in this embodiment can also be obtained when the division is an hour, a minute, a second, etc., instead of 6 hours.

Reference codes 602 through 605 denote the percentages of voice calls, unrestricted digital calls, packet A calls, and packet B calls, respectively, in each time period. The same kind of effect as in this embodiment can also be obtained when classification is performed with other service-related attributes in addition to these, such as handover between cells and handover between sectors.

First, the method whereby traffic recording section 110 collects traffic information will be described. Radio resource monitoring section 109 monitors each occurrence of call generation and clearance. In this embodiment, recording is performed in traffic recording section 110 for each call generation and clearance. The effect of this embodiment can also be obtained if traffic monitoring and recording are performed periodically rather than for call generation and clearance.

Next, the method is shown whereby radio resource monitoring section 109 performs resource relocation using information in traffic recording section 110. It is assumed that actual measurement data has already been recorded in traffic recording section 110. By this means, traffic recording section 110 determines the calls that are given priority in each time period. For example, according to the White Paper on Information and Communication for fiscal 2002 published by the Japanese Ministry of Management and Coordination, many e-mails are sent to mobile phones in the evening but voice calls increase late at night, and it is therefore assumed in this embodiment that the relocation processing threshold value is changed in line with the calls that represent the greatest proportion of calls generated in each time period, facilitating as far as possible the accommodation of the most frequently generated calls.

In FIG. 7, the percentage of packet B calls is high in the time period from 12:00 to 18:00. In this case, in order to accommodate the next packet call generated, it is necessary to provide 16 vacant resources in one or another signal processing card. Thus, in this embodiment, to prevent a situation in which a packet B call cannot be accommodated, radio resource monitoring section 109 begins resource relocation processing when there are no longer 16 or more vacancies in any card.

In the time period from 18:00 to 24:00, on the other hand, the voice call percentage is high and therefore voice calls are given priority, but as the number of required resources for a voice call is one, resource relocation processing is not activated in this case. Although not shown in FIG. 7, resource relocation processing is activated if there are no signal processing cards with six or more vacant resources when packet A calls are given priority for accommodation, or if there are not three vacant resources in any signal processing card when unrestricted digital calls are given priority.

This concludes an explanation of threshold value determination by the traffic recording section.

In this embodiment the threshold value is set to 16 in order to accommodate packet B calls, assuming the time periods in which many packet B calls are generated under the traffic conditions in FIG. 7. Specifically, when there is no card with vacancies equivalent to 16 resources, processing is performed to create the vacant resources necessary for packet B call allocation by shifting a call allocated to the signal processing card with the smallest number of used resources in signal processing section 106 to another signal processing card.

Resource relocation processing according to this embodiment will now be described in detail. Referring to FIG. 3, a state is first assumed in which unrestricted digital call 203 has not been allocated.

Before unrestricted digital call 203 is generated, there are 16 vacancies in fourth signal processing card 106d (the remainder after subtracting 16 packet B call resources from the number of installed resources, 32) and therefore resource allocation processing is performed in base transceiver station 102 in the usual way, and unrestricted digital call 203 is allocated to fourth signal processing card 106d which, with 16 vacant resources, is the only card that can accommodate an unrestricted digital call.

Immediately after allocation is performed, the vacancy [4] field in management table 301 of signal processing section 106, indicating the number of vacant resources in fourth signal processing card 106d, is rewritten from 16 to 13. As a result, radio resource monitoring section 109 monitoring signal processing section 106 detects that there is no signal processing card holding the threshold number of vacant resources (16).

In this embodiment, the monitoring timing is assumed to be after the end of call allocation, but the same kind of effect as in this embodiment can also be achieved by performing processing that monitors the number of vacant resources of each signal processing card periodically or each time a call is generated.

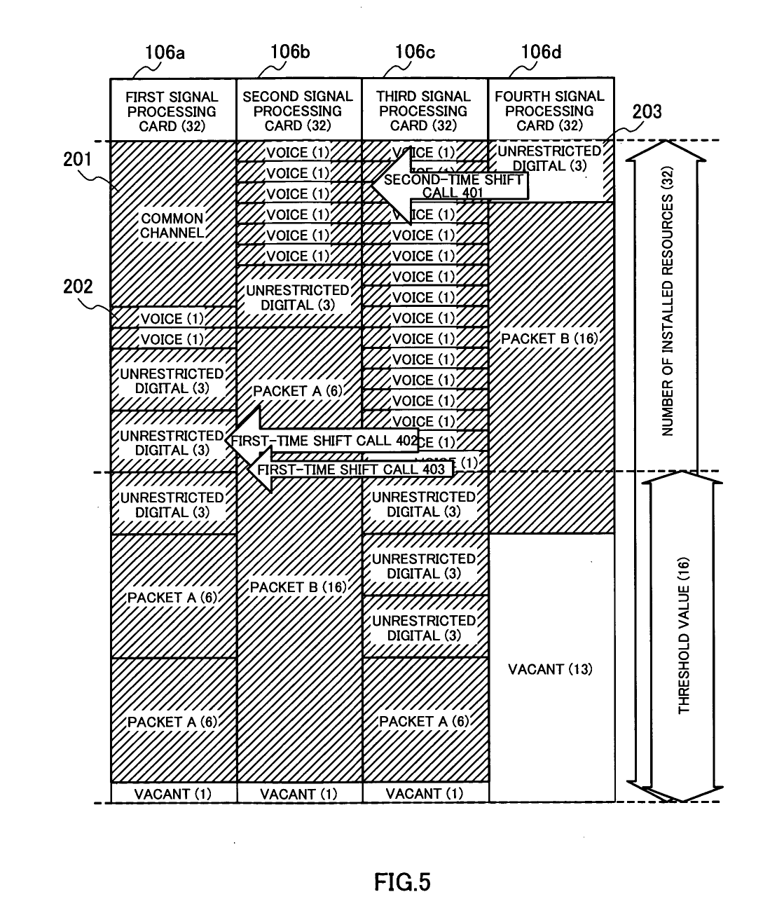

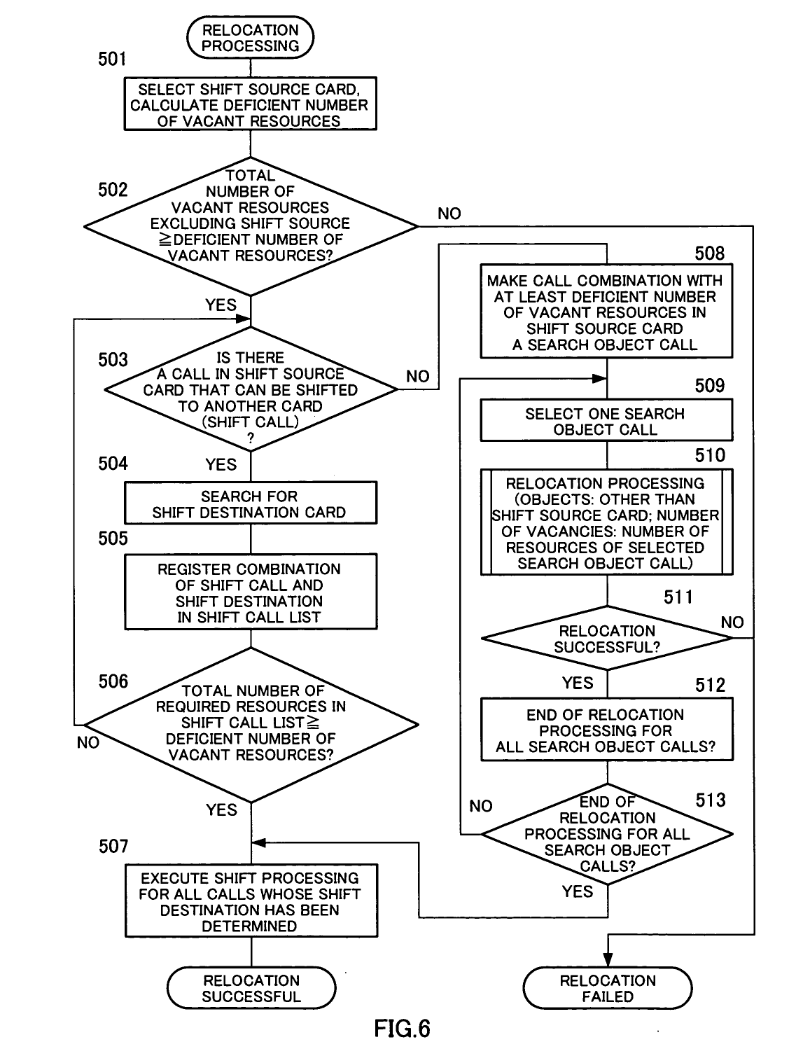

When radio resource monitoring section 109 detects that there is no signal processing card that has vacant resources equivalent to the threshold value, it begins processing to secure the threshold value of 16 vacant resources in a signal processing card by shifting a call of the signal processing card with the greatest number of vacancies to another signal processing card that has vacant resources. An overview of this processing in the state in FIG. 3 is shown in FIG. 5, and a flowchart is shown in FIG. 6.

In FIG. 3, if unrestricted digital call 203 in fourth signal processing card 106d is shifted to another signal processing card, the number of vacant resources becomes 13+3=16, equal to the threshold value. This call is thus shifted to another signal processing card, and will be referred to as the “shift source call” hereinafter.

Fourth signal processing card 106d accommodates a packet B call as well as an unrestricted digital call, but in FIG. 3 the total number of vacant resources of signal processing cards other than fourth signal processing card 106d is 3, less than the number of required resources for a packet B call, and therefore this packet B call cannot be shifted to another card.

Therefore, fourth signal processing card 106d is selected as the shift source card, and unrestricted digital call 203 as shift call 401 of the shift source card, and thereafter, the following kind of processing is performed in FIG. 5 to eliminate vacant resources of the lowest-numbered signal processing card possible. The same kind of effect as in this embodiment can be achieved using any signal processing card search order.

First, an attempt is made to shift shift call 401 from the shift source card, fourth signal processing card 106d. However, the vacancies in first signal processing card 106a through third signal processing card 106c are all 1, and no signal processing card has sufficient vacant resources to accommodate an unrestricted digital call. Thus, a voice call is shifted from third signal processing card 106c to each of first signal processing card 106a and second signal processing card 106b as shift calls 402 and 403. Vacant resources with a size of 3 are then created in third signal processing card 106c, and therefore unrestricted digital call 203, which is shift call 401 of the shift source card, is shifted from fourth signal processing card 106d to third signal processing card 106c. By this means, 16 vacant resources, equivalent to the threshold number, are secured in fourth signal processing card 106d, and if another packet B call is generated subsequently it can be accommodated.

When resource shifting is carried out, radio resource control section 107 first reserves shift destination resources so that even if another call is generated it will not be allocated to the shift destination resources. Then, when signal processing synchronization is established for the shift source and shift destination resources, connection control section 105 outputs a request to signal processing section 106 to switch resources allocated to the call from the shift source to the shift destination. When resource switching is performed, signal processing section 106 releases the shift source resources. This release is reflected immediately to the management table in radio resource control section 107.

This concludes an overview of relocation processing according to this embodiment.

If there are a plurality of shift source calls, the same kind of effect as in this embodiment can be obtained by repeating shift source call shift processing.

The resource relocation scheme will now be described using the flowchart in FIG. 6.

In this embodiment, relocation processing according to this embodiment is activated when the number of vacant resources becomes less than the threshold value.

In executing relocation processing, it is necessary to specify two items—the group of signal processing cards subject to relocation processing (cards) and the number of vacant resources to be realized by relocation (resource_threshold)—as “relocate” (cards, resource_th reshold). Immediately after relocation processing is activated, all the cards installed in the base transceiver station are subject to relocation processing—that is, first signal processing card 106a through fourth signal processing card 106d. Meanwhile, the threshold value of the number of vacant resources to be realized by relocation is 16. Thus, the initial activation calling format is relocate (1 to 4, 16).

In processing 501, the call shift source card is determined. In the case shown in FIG. 3, of the subject signal processing cards, fourth signal processing card 106d having the largest number of vacant resources is taken as the shift source card. Other possible shift source card selection methods include methods using the highest-numbered or lowest-numbered signal processing card rather than the signal processing card with the largest number of vacant resources. Next, the deficient number of vacant resources {(threshold value)−(number of vacant resources of shift source card)} “shortage” in the shift source card is calculated. Since resource_threshold is 16 and the number of vacant resources is 13, in this case shortage is (16−13=) 3.

In processing 502, the total number of vacant resources of cards subject to relocation processing other than the shift source card is compared with shortage, and it is confirmed whether or not vacant resources equivalent to the threshold value can be created. If shortage is greater, the total number of vacant resources of cards subject to relocation is less than the threshold value, and vacant resources equivalent to the threshold value cannot be created even if resources are relocated, so processing is terminated. In the case shown in FIG. 3, since fourth signal processing card 106d is the shift source card, the total number of vacant resources of cards other than the shift source card is the total number of vacant resources of the first through third signal processing cards—that is, 3. Thus, since this is equal to the value of shortage, the processing flow proceeds to processing 503.

In processing 503, a call that can be shifted from the shift source card to another signal processing card (a call whose number of required resources does not exceed vacant resources vacancy [i] in any i'th signal processing card other than the shift source) is searched for, and the result is determined. In the case shown in FIG. 3, since the calls accommodated in fourth signal processing card 106d are an unrestricted digital call and a packet B call, and there is only a maximum of one vacancy in each of the other signal processing cards, the search for a shiftable call fails. Therefore, processing 508 onward is next executed.

In the series of processing steps from processing 508 onward on the right-hand side of FIG. 6, since a shift of a call from the shift source card is not immediately possible, vacant resources capable of accommodating the call that is wished to be shifted are created by executing relocation processing recursively with cards other than the shift source card.

In processing 508, a combination of calls necessary for creating the deficient vacant resources in the shift source card are extracted from the shift source card, and made a shift candidate call group. In the case shown in FIG. 3, deficient vacant resources in fourth signal processing card 106d are 3. In the shift source card, the call with the smallest resource size is the unrestricted digital call whose number of required resources is 3, and the deficiency in vacant resources can be eliminated by shifting this call to another signal processing card. Therefore, here this unrestricted digital call is shifted.

In processing 509, one shift destination search object call for searching for a shift destination card based on the number of required resources is selected from the shift candidate call group. Possible approaches to shift destination search object call determination include high-to-low order of number of required resources, low-to-high order of number of required resources, previously accommodated order, and newly accommodated order. The effect of the present invention can be achieved whichever method is selected. In the case shown in FIG. 3, unrestricted digital call 203, the only call existing in the shift candidate call combination, becomes th shift destination search object call.

In processing 510, call relocation processing is performed. In this case, relocation processing is performed to create the number of vacant resources necessary to accommodate unrestricted digital call 203, the previously selected shift destination search object call, from the shift source card to another card. Signal processing cards that are shift destination objects here are first signal processing card 106a through third signal processing card 106c (fourth signal processing card 106d—the shift source card—being excluded), and the number of resources that must be made vacant by relocation processing is 3—the number of required resources for the unrestricted digital call for which the search is being conducted (the search object call). Thus, the calling format is relocate (1 to 3,3).

Details of relocation processing include recursive processing of processing steps 501 through 506. That is to say, since there is at present no accommodation destination for unrestricted digital call 203, of which number of resources is 3, apart from the shift source card (as determined in processing 503), the processing flow does not proceed to processing 508, but, instead, relocation processing is performed to accommodate unrestricted digital call 203 in another card. The processing in processing steps 501 through 506 when the processing flow proceeds from processing 503 to processing 504 will be described later herein. As a result, two voice calls in third signal processing card 106c are shifted to other signal processing cards, as shown in FIG. 5. Thus, vacancies equivalent to three resources are created in third signal processing card 106c.

In processing 511, it is determined whether or not relocation processing to accommodate the unrestricted digital call in the third signal processing card has been successful, and vacant resources have been created. In the case shown in FIG. 3, relocation processing succeeds by shifting one voice call each from the third signal processing card to the first signal processing card and the second signal processing card, and therefore the processing flow proceeds to processing 512.

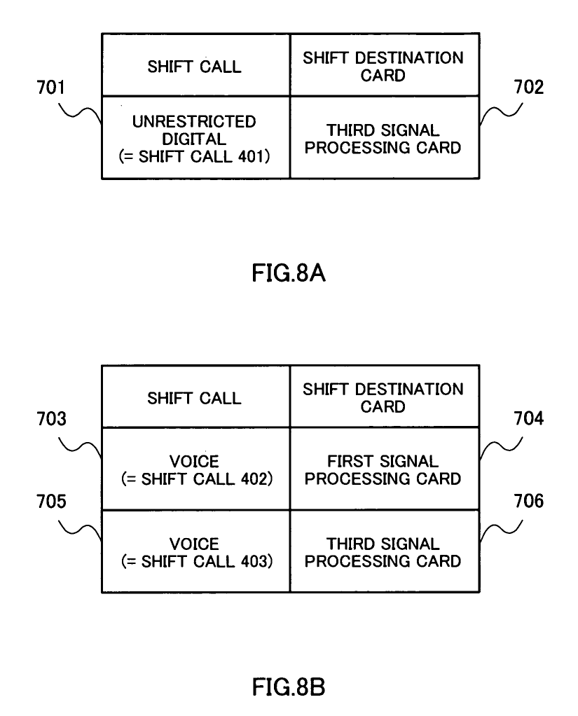

In processing 512, the search object call and vacant card are added to a shift destination list. The shift destination list is a list of combinations of calls shifted by relocation processing and the corresponding shift destination card numbers. As shown in FIG. 8A, a combination of a fourth signal processing card 106d unrestricted digital call and third signal processing card 106c in which resources were made vacant by relocation processing is added to the shift call list. Shift calls 402 and 403 described earlier herein are registered here.

In processing 513, end determination is performed for all shift candidate calls. In the case shown in FIG. 3, there is only one shift destination search object call—unrestricted digital call 203—for which vacant resources are created in a shift destination card, and therefore the loop ends immediately, and the processing flow proceeds to processing 507.

In processing 507, shifting processing is performed for all calls whose shift destination has been determined registered in the shift call list. In the case shown in FIG. 3, it has been possible to create 16 vacancies in fourth signal processing card 106d, enabling a packet B call to be accommodated.

This concludes a detailed description of overall relocation processing.

Next, a detailed description will be given of processing 501 through processing 506 when relocation processing is called recursively by processing 510 in the overall processing.

In this processing, in order to shift unrestricted digital call 203 in fourth signal processing card 106d, relocation processing is recursively called with relocate (1 to 3,3), and three vacant resources, equivalent to the threshold value (resource_threshold), are created in one of the first through third signal processing cards.

In processing 501, in the case shown in FIG. 3 there are a plurality of (3) signals processing cards that are target signal processing cards and have a maximum number of vacant resources of one. Among these, in order to eliminate low-numbered vacant resources as far as possible, third signal processing card 106c, which is the highest-numbered card among those having vacant resources, is decided on as the shift source card. The deficient number of resources, “shortage,” is {(resource_threshold)−(vacancy [3])=3−1=}2.

Below, an attempt is made to shift two calls to another card to create three vacant resources in third signal processing card 106c.

In processing 502, the total number of vacant resources in FIG. 3, excluding the shift source, is {(vacancy [1])+(vacancy [2])=1+1=}2, equal to the value of shortage. Therefore, the processing flow proceeds to processing 503.

In processing 503, the search results are determined. In the case shown in FIG. 3, third signal processing card 106c accommodates voice calls, and therefore one call can be found among these as a call to be shifted. Therefore, processing from 504 onward is executed next.

In processing 504, the shift destination is selected after excluding the third signal processing card—the shift source card—from the cards subject to relocation (relocation object cards) “cards” (the first through third cards). In the case shown in FIG. 3, the number of vacant resources is 1 in both the first and second signal processing cards, enabling a voice call to be accommodated. In this case, since the policy is to accommodate a call in the lowest-numbered signal processing card possible, first signal processing card 106a is selected. The same kind of effect as in this embodiment can also be obtained if a high-to-low number order is used as the shift destination card order.

In processing 505, as shown in FIG. 8B, the combination of a third signal processing card 106c voice call and searched first signal processing card 106a in FIG. 3 is added to the shift call list. Combinations of calls whose shift destination has been decided and the corresponding shift destination are registered in the shift call list. Shift call 401 described earlier is registered here.

In processing 506, it is determined whether processing has ended for all shift candidate calls. In the case shown in FIG. 3, there is one voice call in the list of calls whose shift destination has been determined, and the insufficient number of calls—“shortage”—is two. The processing flow therefore returns to processing 503 again.

Second-time processing 50.2 through processing 505 proceeds in substantially the same way as the first time, and one voice call in third signal processing card 106c is shifted to second signal processing card 106b.

In second-time processing 506, the shift call list includes two calls—two voice calls—and since the insufficient number of calls “shortage” is the same number, two, the processing flow proceeds to processing 507, resource relocation processing is performed for all calls whose shift destination has been determined, and processing is terminated.

This concludes a description of resource relocation processing called recursively.

In the case shown in FIG. 3, an algorithm is used that creates vacant resources starting from the lowest-numbered signal processing card, but the same kind of result can also be obtained if vacant resources are secured by shifting calls in other signal processing cards. For example, in this embodiment, five voice calls in second signal processing card 106b or second signal processing card 106b may be shifted to other resources in order to create six vacancies.

Also, if many calls are shifted simultaneously from a particular signal processing card, there is a possibility of the card being overloaded, and therefore the effect of the present invention can also be achieved if an upper limit is set for the total number of resources of calls shifted at a time.

In this embodiment, the position at which a call is located may be anywhere in each signal processing card, and it has been sufficient to ascertain only the number of vacant resources in a management table in the radio resource control section, but, when location of a call cannot be located at an arbitrary place in a signal processing card and vacant resources are separated into two resources and one resource within the same card after the two voice calls in the first signal processing card in FIG. 3 are deallocated, it is possible to apply the algorithm of this embodiment by storing the locations and sizes of consecutive vacant resources rather than using a card-by-card vacancy structure. At this time, if the call shiftability is determined by comparing the threshold value used as a relocation processing termination condition with the maximum number of consecutive vacant resources in a card, and also with the size of all consecutive vacant resources of each card in shift destination detection, it is possible to perform resource relocation processing in the same way as described in this embodiment.

Even if there is a restriction on resource allocation locations such that, for example, a packet A call cannot be allocated to resources other than the eighth and subsequent resources from the start, the possibility of allocating a call that is wished to be accommodated constituting a threshold value determination factor is monitored, rather than the threshold value, and when the accommodation is not possible, the same kind of effect as in this embodiment can be still achieved by having radio resource monitoring section 109 perform resource relocation processing enabling the target call to be accommodated while satisfying the restriction condition using radio resource control section 107 in the same way as in this embodiment.

That is to say, it is necessary to select the card closest to the state in which a packet A call is allocated from the state of the eighth and subsequent resources from the start of each card, and shift a call in that card to another signal processing card.

In this embodiment, resource relocation is executed in two stages using recursion, but, when resource relocation is performed without interruption it is necessary to implement signal synchronization at both shift source and shift destination resources, and shift processing takes 100 ms or more from start to finish. As there is a possibility of call loss occurring if a new call is generated at this time, if the radio resource control section is activated and relocation is performed when it is possible to accommodate two or more packet A calls in the overall signal processing procedure, for example, the probability of call loss occurring during relocation processing execution can be reduced compared with a case where resource relocation processing is only activated when even one packet A call cannot be accommodated.

For the sake of simplicity, recursion has been used in this flowchart, but in fact the effect is the same if loop-based repeat processing is used.

In this processing example, in order to eliminate vacant resources in a shift destination signal processing card as far as possible for the sake of efficiency, shift destination call selection is carried out so that the number of required resources of the shift source call and the number of vacant resources of the shift destination are as close to each other as possible. If the respective numbers of vacant resources in a plurality of signal processing cards that are shift destination candidates is the same, shifting is performed so that a call is accommodated in the lowest-numbered card of those signal processing cards. The same kind of effect can be obtained with a number priority order whereby a call is accommodated preferentially in the highest-numbered signal processing card.

As described above, in this embodiment, an effect can be obtained of accommodating a new call without disconnecting an existing call, reducing call loss, and increasing the accommodation capability of a base transceiver station, with a configuration where a traffic recording section is provided, a resource monitoring section dynamically rewrites based on data stored in the traffic recording section a threshold value that is a condition for activating resource relocation processing, and a radio resource control section, which performs relocation repeatedly until the threshold value is reached, and a radio resource monitoring section, which monitors the maximum size of vacant resources and activates the radio resource control section when this size is less than or equal to the threshold value, are provided.

### Embodiment 2

A second embodiment of the present invention will now be described.

It is an object of this embodiment to prevent call loss occurring in base transceiver stations due to execution of terminal resource relocation (handover) when a terminal is under a plurality of base transceiver stations.

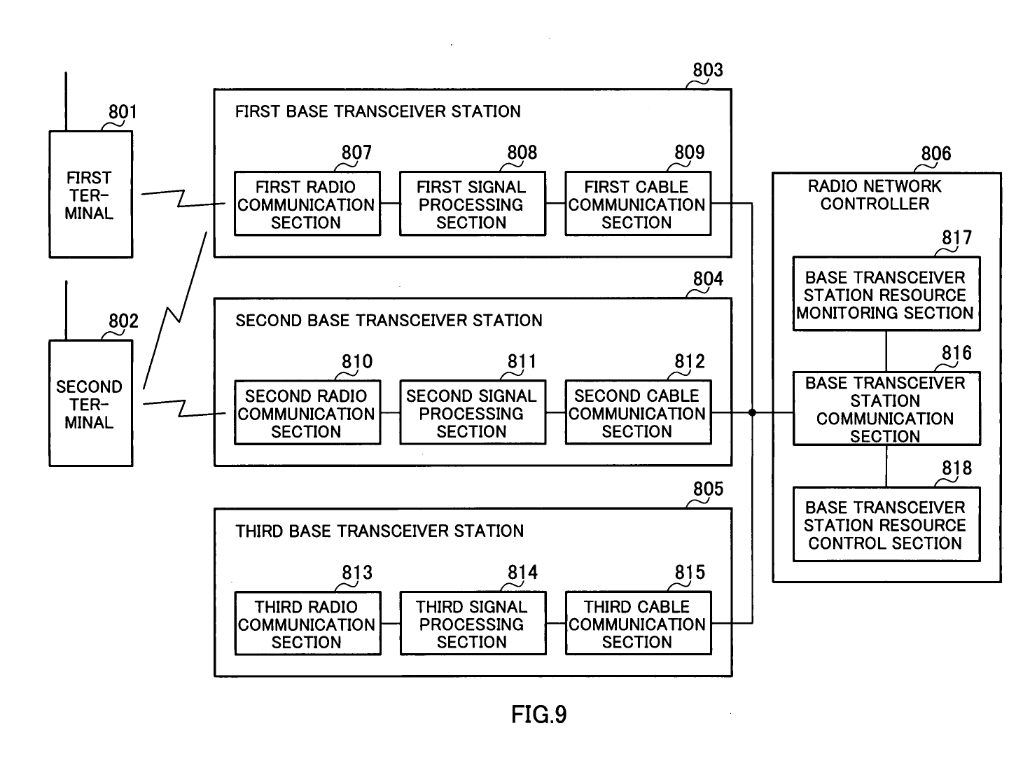

A block diagram of a system configuration according to this embodiment is shown in FIG. 9.

In FIG. 9, reference codes 801 and 802 denote a first terminal and second terminal, respectively.

Reference codes 803, 804, and 805 denote a first base transceiver station, second base transceiver station, and third base transceiver station respectively.

In this embodiment, it is assumed that all base transceiver stations are of small scale and a large number of base transceiver stations are located in buildings or nearby places, and that there is significant overlapping of the coverage areas of various base transceiver stations. It is here assumed in that terminal 801 is accommodated only in first base transceiver station 803 and cannot communicate with other base transceiver stations, while second terminal 802 is accommodated in first base transceiver station 803 and second base transceiver station 804, and is now performing diversity handover. With regard to second terminal 802, it is not necessary for diversity handover to be performed, and it is sufficient to be able to communicate with both first base transceiver station 803 and second base transceiver station 804.

Reference code 806 denotes a radio network controller that is connected to first base transceiver station 803 through third base transceiver station 805, and outputs requests relating to call connection and disconnection to all the base transceiver stations.

FIG. 9 illustrates the internal structure of the base transceiver stations. The internal structure of base transceiver stations according to this embodiment has been simplified for ease of explanaiton.

A first radio communication section 807, second radio communication section 810, and third radio communication section 813 perform transmit/receive processing such as amplification and modulation on radio signals to/from terminals.

A first signal processing section 808, second signal processing section 811, and third signal processing section 814 perform signal processing such as radio signal code modulation processing and conversion to a cable signal. Each of these is assumed to have 16×8=128 resources. In this embodiment, for the sake of simplicity, it is assumed that the interior of each signal processing section is not divided into signal processing cards as in Embodiment 1. Also, in this embodiment these numbers of vacant resources are designated vacancy [1] through vacancy [3] respectively.

It is possible to obtain the effect of the present invention even if this number of resources differs or the number of resources accommodated by each base transceiver station differs.

A first cable communication section 809, second cable communication section 812, and third cable communication section 815 perform communication with radio network controller 806.

The internal structure of radio network controller 806 will now be described.

Reference code 816 denotes a base transceiver station communication section.

Reference code 817 denotes a base transceiver station resource monitoring section that manages the number of remaining resources of all the base transceiver stations connected to radio network controller 806.

Reference code 818 denotes a base transceiver station resource control section that performs resource allocation and deallocation for all the base transceiver stations connected to radio network controller 806.

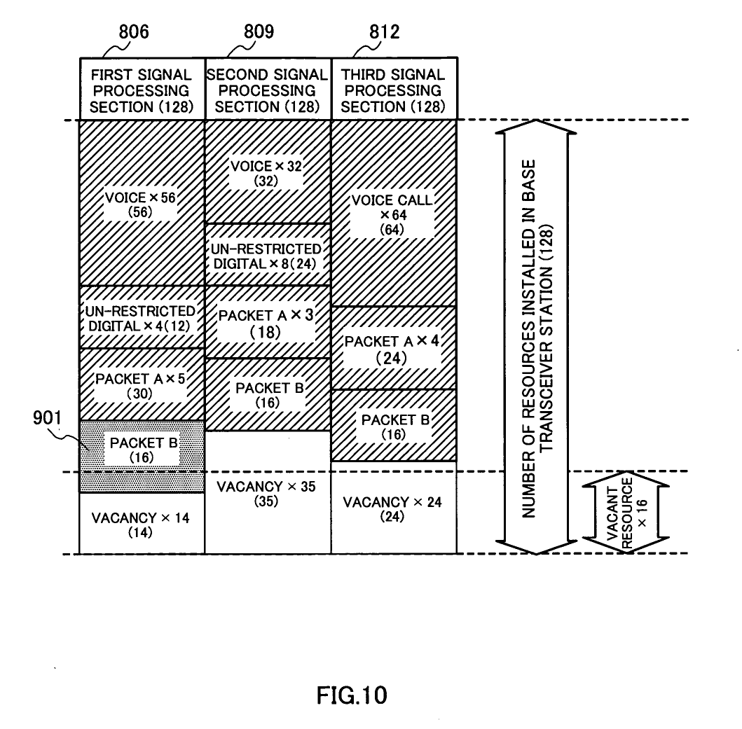

FIG. 10 is diagram showing the state of the signal processing section of each base transceiver station. Each base transceiver station accommodates voice calls, unrestricted digital calls, packet A calls, and packet B calls. First signal processing section 808 accommodates 56 voice calls, four unrestricted digital calls, five packet A calls, and one packet B call. The number of remaining resources is 128−1×56−3×4−6×5−16×1=14. The situation is similar for second signal processing section 811 and third signal processing section 814.

The operation of this embodiment will now be explained.

In this system, the type of call for which the number of required resources is greatest is a packet B call. Therefore, except for a case where traffic is excessive for all base transceiver stations, radio network controller 806 secures 16 vacant resources to ensure that a packet B call can be accommodated when generated. That is to say, the number of vacant resources of 16 is made the threshold value (resource_threshold).

In the situation shown in FIG. 10, the number of vacant resources of first base transceiver station 803 is 14, and therefore base transceiver station resource monitoring section 817 detects this and requests base transceiver station resource control section 818 to increase the number of vacant resources of first base transceiver station 803.

First, if there is a call in the process of diversity handover between first base transceiver station 803 and another base transceiver station, as in the case of second terminal 802, connection of that call on the first base transceiver station 803 side is cut. Even if a call in the process of diversity handover is disconnected, the terminal is connected to another base transceiver station, enabling the number of resources of first base transceiver station 803 to be made 16 or more without call disconnection.

On the other hand, if there is no call in the process of diversity handover, vacant resources are secured in first base transceiver station 803 by shifting (handing over) a call from first base transceiver station 803 to another base transceiver station.

A call to be shifted should be able to access a common channel of both first base transceiver station 803 and another base transceiver station, as in the case of second terminal 802. When the coverage areas of base transceiver stations overlap, as in this embodiment, a call in first base transceiver station 803 can be handed over to either second base transceiver station 804 or third base transceiver station 805, and therefore of these, the base transceiver station with the greatest number of vacant resources is selected as the shift destination. In this case, second base transceiver station 804 has the greater number of vacant resources (35), and therefore second base transceiver station 804 is made the shift destination.

If the number of vacant resources in the shift destination base transceiver station is 16 or more even after a call has been shifted, the same kind of effect can be obtained as in the present invention even if the number of vacant resources is not the maximum. Next, the call to be shifted is selected.

As it is necessary to secure 16 vacant resources in the shift destination base transceiver station, the number of resources of a call to be shifted needs to be less than the value resulting from subtracting 16 from the number of vacant resources of the shift destination base transceiver station. In this case, since the number of vacant resources of shift destination second base transceiver station 804 is 34, the upper limit of the number of resources of a call to be shifted is 18, and therefore any kind of call can be shifted. Thus, it is determined that packet B call 901 for which the number of required resources is greatest is to be shifted to second base transceiver station 804.

The base transceiver station resource control section of radio network controller 806 outputs a request via base transceiver station communication section 816 for a packet B call to be handed over to second base transceiver station 804 by second terminal 802 being under control of first base transceiver station 803. This request passes through first cable communication section 809, first signal processing section 808, and first radio communication section 807 in first base transceiver station 803, and is output to second terminal 802. Second terminal 802 performs processing for handover to second base transceiver station 804 in accordance with this request, enabling vacant resources in first base transceiver station 803 to be secured.

As described above, according to this embodiment, by providing a base transceiver station resource monitoring section and a base transceiver station resource control section in a radio network controller, and performing resource relocation among a plurality of base transceiver stations whose coverage areas overlap, an effect can be obtained of preventing base transceiver station load distribution and loss of calls from terminals, and improving resource utilization.

### Embodiment 3

This embodiment shows a scheme for performing resource relocation efficiently when there are a plurality of hardware units such as LSIs performing signal processing in a signal processing card, and there is a restriction that does not enable resources for one call to be allocated across a plurality of hardware units.

This algorithm is particularly effective when traffic is heavy but there are vacant resources overall in the signal processing cards installed in a base transceiver station, and those vacant resources are dispersed among a plurality of cards.

In the following description, hardware that performs signal processing, of which a plurality are present in a signal processing card, is referred to as a unit.

This third embodiment of the present invention will now be described.

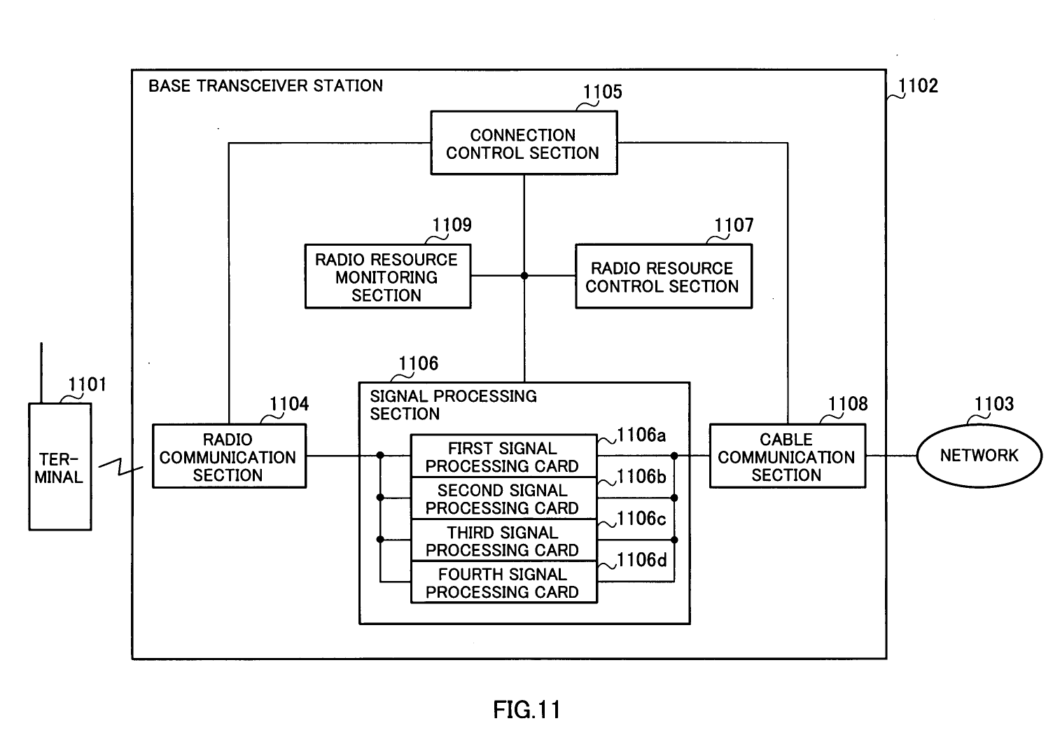

FIG. 11 shows a block configuration diagram of the present invention.

In FIG. 11, reference codes 1101 through 1108 correspond to reference codes 11 through 18 in the example of the prior art. In FIG. 11, reference code 1101 denotes a terminal. In subsequent descriptions a terminal is assumed to be a W-CDMA (Wideband Code Division Multiple Access) or MC-CDMA (Multi-Carrier CDMA) third-generation mobile phone, but the present invention can also be applied to a GSM (Global System for Mobile communications), PHS (Personal Handy-phone System), PDC (Personal Digital Cellular), or other mobile phone or cordless phone.

Reference code 1102 denotes a base transceiver station that accommodates terminals, performs radio signal transmission/reception to/from terminals, and converts radio signals to cable signals.

Reference code 1103 denotes a network that has a switching function. Network 1103 is connected to the base transceiver station via a dedicated line and ATM (Asynchronous Transfer Mode).

Reference codes 1104 through 109 denote internal components of the base transceiver station.

Reference code 1104 denotes a radio communication section that performs radio signal transmission/reception to/from terminal 1101.

Radio communication section 1104 performs signal reception by means of an antenna, terminal transmission power control, frequency modulation processing; and so forth. Radio communication section 1104 is equipped with an antenna, an amplifier, a transmission power source, and a control program.

Reference code 1105 denotes a connection control section that controls connection/disconnection of communication paths for terminals in accordance with requests from network 1103. The connection control section is implemented as a program in a control card of the base transceiver station.

Reference code 1106 denotes a signal processing section that performs signal processing on a radio signal from a terminal, such as code modulation processing and conversion to a cable signal. In order for many terminals to be accommodated by the base transceiver station simultaneously, the signal processing section has a configuration equipped with many cards and LSIs of identical format, and hardware units formed with combinations thereof. In this embodiment it is assumed that the base transceiver station is equipped with four sets of the same kind of hardware, designated first signal processing card 1106a through fourth signal processing card 1106d.

Reference code 1107 denotes a radio resource control section that performs allocation/deallocation of a generated call to/from a signal processing card in signal processing section 1106.

Reference code 1108 denotes a cable communication section that performs signal transmission/reception to/from network 1103.

Reference code 1109 denotes a radio resource monitoring section that performs monitoring of the state of the signal processing section and determines whether or not call relocation is necessary, and, when call relocation is necessary, issues a resource relocation directive to the radio resource control section.

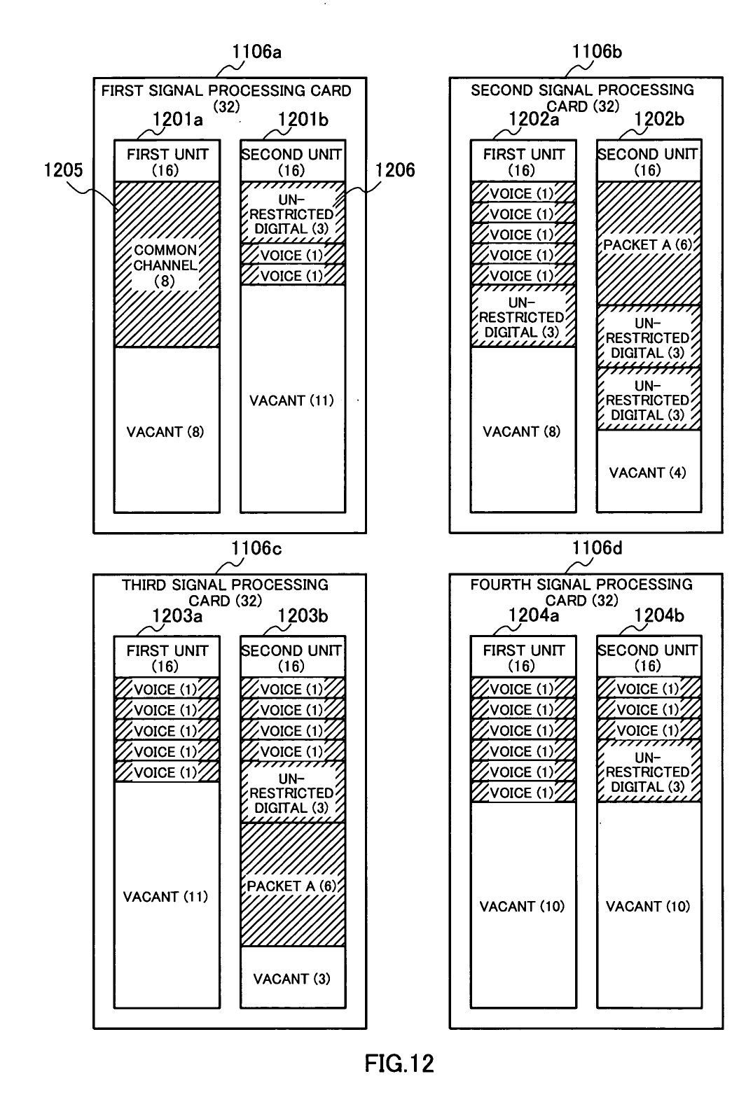

Next, FIG. 12 will be explained. FIG. 12 shows the state of signal processing section 1106. The number of signal processing cards in signal processing section 1106 is assumed to be 4, and, as in the prior art, each signal processing card has 768 kbps signal processing capability, one resource is defined as 24 kbps signal processing capability, and the base transceiver station supports the following types of calls.

(a) Voice call 1 resource

(b) Unrestricted digital call (64 kbps) 3 resources

(c) Packet A call (128 kbps) 6 resources

(d) Packet B call (384 kbps) 16 resources

(e) Common channel 8 resources

The types of calls supported differ according to the communication provider providing communication services. With regard to the resource number unit, speed increases or decreases according to the hardware of the base transceiver station, and the speed unit may also be sps (Symbols Per Second).

With the present invention, the same kind of effect can be obtained even if the numbers of signal processing cards in the signal processing section, the signal processing card processing capability, and/or the unit for the number of resources vary. Also, even if the (downlink) communication speed from the base transceiver station to a terminal and the (uplink) communication speed from a terminal to the base transceiver station differ, and resources used for processing of both are secured separately, it is possible to apply the present invention by, for example, performing resource allocation with the number of required resources of the service determined by whichever of the uplink or downlink number of required resources is greater.

The configuration of signal processing section 1106 according to the third embodiment will now be described using FIG. 12.

First signal processing card 1106a through fourth signal processing card 1106d in FIG. 12 are each divided into a first unit (1201a through 1204a) and second unit (1201b through 1204b). Each unit is formed with hardware that performs baseband processing, such as an LSI, DSP, and so forth. In a normal base transceiver station, there is no mechanism for synchronizing signals processed among a plurality of units in order to simplify the channel configuration, and therefore one call must be processed by one unit.

FIG. 12 shows the state in which the base transceiver station is operating. For example, it is shown that in first signal processing card 1106a, a common channel (number of resources 8) is allocated to first unit 1201a, and an unrestricted digital call (number of required resources=3) and two voice calls (number of required resources=1 each) are allocated to second unit 1201b.

In this embodiment, the number of vacant resources is denoted by the card number and unit number, thus: vacancy [1] [1]=16−8=8. If there is only one subscript, as in vacancy[i], this indicates the number of vacant resources in i'th signal processing card 1106d. That is to say, vacancy [i]=vacancy [i] [1]+vacancy [i] [2].

In this embodiment, it is assumed that the position at which a call is located may be anywhere in any signal processing card. Therefore, it is sufficient to be able to ascertain only the number of vacant resources in a management table in the radio resource control section. For example, in FIG. 12, when unrestricted digital call 1206 is deallocated, the number of vacant resources in the fourth signal processing card is 16—the total of the number of vacant resources of the partial accommodating unrestricted digital call 1206 (3) and the number of vacant resources from before unrestricted digital call 1206 is deallocated (13)—and vacant resources are not divided into two numbers of vacant resources, 3 and 13.

A description will first be given with call processing in base transceiver station 1102 divided between a common channel used for terminal 1101 calling and so forth, and dedicated channels allocated to voice calls, unrestricted digital calls, packet calls, and so forth on a terminal-by-terminal basis.

Common channel 1205 is used for calling to terminals, and is secured immediately after base transceiver station startup.

Here, assuming that call allocation to signal processing cards is performed in low-to-high number order, radio resource allocation section 1104 assigns resources that process the common channel to the first signal processing card.

Apart from using low-to-high card number order, other possible methods of determining the allocation destination signal processing card are to perform allocation in high-to-low number order, to start allocation from the signal processing card with the smallest number of vacant resources among all the signal processing cards, or to start allocation from the signal processing card with the largest number of vacant resources among all the signal processing cards. The effect of the present invention can be achieved with any of these methods.

On the other hand, dedicated channel securement is performed as follows. First, when terminal 1101 enters the coverage area of base transceiver station 1102, ATTACH processing (processing that registers the location of the terminal in the network, and places the terminal in a state in which call termination is possible) is performed with respect to network 1103. Although resources are actually also used in terminal ATTACH processing, it is possible to achieve the effect of the present invention in this case also. However, in terms of resource allocation and relocation algorithm processing according to the present invention, the handling of ATTACH processing is the same as for other calls, and, to simplify the description, resources used in ATTACH processing are not considered in the present invention.

Following location registration, when terminal 1101 originates an unrestricted digital call, base transceiver station 1102 establishes a communication path to be used for a call between terminal 1101 and network 1103, and allocates unrestricted digital call resources 1206 to second unit 1201b of first signal processing card 1106a.

The resource allocation procedure will now be described in detail. The procedure is also similar when allocating other kinds of call.

First, terminal 1101 outputs an origination request to network 1103 via base transceiver station 1102 on the common channel. On receiving this request, radio communication section 1104 in base transceiver station 1102 first executes demodulation processing and so forth, and outputs the request to first signal processing card 1106a allocated to the common channel in signal processing section 1106. First signal processing card 1106a performs baseband processing and conversion to a cable signal, and outputs the origination request to cable communication section 1108. The cable communication section performs protocol conversion of a signal of the origination request to ATM or the like, and outputs the request to network 1103. In this embodiment, base transceiver station 1102 is controlled only by network 1103, and is not controlled by a signal from a terminal. As the algorithm of the present invention is not related to a resource allocation processing trigger, it is possible for the effect of the present invention to be similarly obtained when resource allocation processing is controlled by a terminal signal.

In response to the origination request, network 1103 outputs a call resource securement request for an unrestricted digital call for terminal 1101 to base transceiver station 1102. Base transceiver station 1102 allocates the call to a suitable signal processing card in accordance with the resource securement request. The procedure whereby base transceiver station 1102 allocates resources in accordance with a resource securement request from network 1103 will now be described in detail.

First, the resource securement request from network 1103 is input to cable communication section 1108. As this resource securement request is a control request for base transceiver station 1102, it is detected by connection control section 1105. Connection control section 1105 outputs to radio resource control section 1107 a request to secure resources for an unrestricted digital call in signal processing section 1106. Radio resource control section 1107 references the management table in signal processing section 1106, and, since there are vacancies in first signal processing card 1106a, the unrestricted digital call is allocated here. This allocated call is voice call 1202 in FIG. 12. Radio resource control section 1107 also decreases the number of vacant resources in its internal management table in accordance with the number of allocated resources.

Possible card selection methods when performing call allocation are to allocate calls in high-to-low card number order among cards that have sufficient vacant resources, or to allocate calls in order starting with the greatest number of vacant resources or the smallest number of vacant resources. As this embodiment shows a method whereby a call is shifted after allocation, the same kind of effect as in this embodiment can also be achieved whatever method is used as the call allocation scheme.

After resource allocation has been performed, connection control section 1105 sets a communication path enabling an unrestricted digital call signal from terminal 1101 to be output appropriately to network 1103 by means of radio communication section 1104, signal processing section 1106 (first signal processing card 1106a), and cable communication section 1108, and outputs a response to the resource securement request to network 1103 via cable communication section 1108. By this means, a communication path from terminal 1101 to network 1103 is established. Thereafter, communication with the calling destination of terminal 1101 is started by means of upper layer call control, but this is not directly related to the present invention and therefore a description thereof is omitted here.

In addition to unrestricted digital calls, FIG. 12 includes voice calls, and packet calls such as packet A and packet B calls. Resource allocation processing is performed in the same way for these calls, except for differences in the number of required resources.

A case has been described here in which a terminal originates a call, but the same kind of allocation procedure as for call origination is also used when a terminal is on the call receiving side, except that a call reception request is generated from the network.

When a call ends, following upper layer call disconnection processing, a resource release request containing a designation of the call to be deallocated is output from network 1103 to base transceiver station 1102. On detecting this request, connection control section 1105 outputs a request to release resources to radio resource control section 1107. Radio resource control section 1107 specifies the signal processing card subject to the release, and has signal processing section 1106 deallocates the relevant call. The number of vacant resources of the relevant signal processing card is also increased in the management table in radio resource control section 1107.

This concludes an overview of call connection/disconnection processing and resource allocation that form the basis of the present invention.

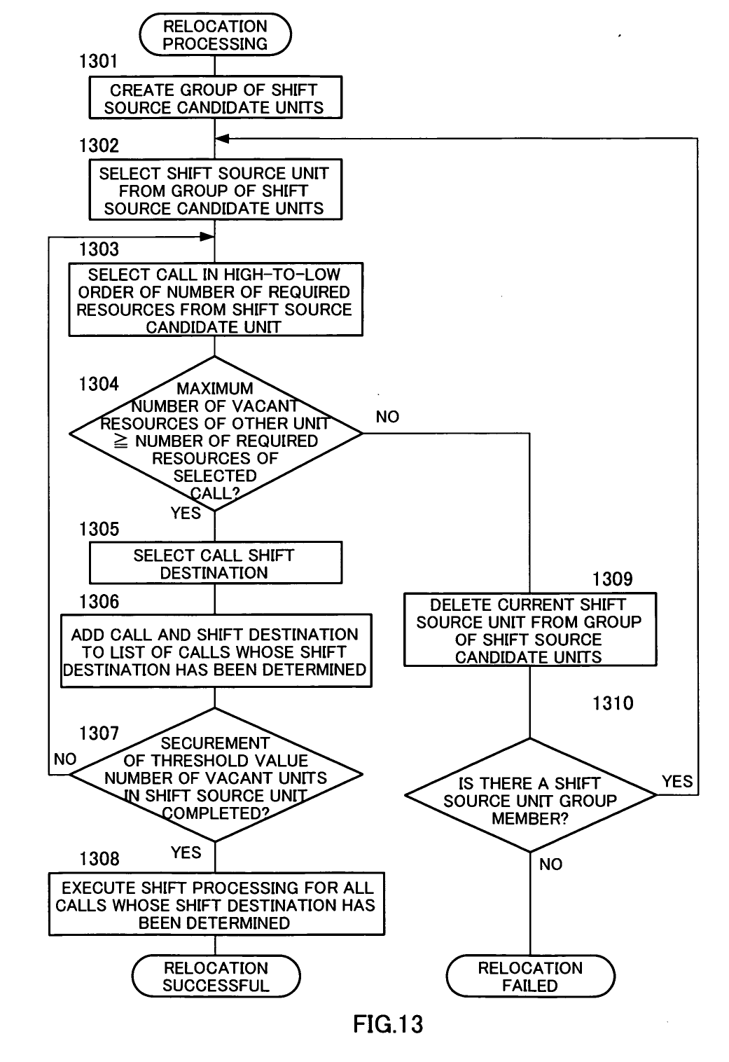

Next, processing in this embodiment will be shown using FIG. 13, which is a flowchart showing the resource relocation processing method of this embodiment.

It is assumed in this embodiment that in order to prevent the loss of 384 kbps packet B calls as far as possible resource shifting is performed so as to enable a packet B call to be accommodated in a signal processing card even when traffic is heavy.

The type of call that makes accommodation possible by relocation may be a different type of call. When a packet B call can be accommodated in any signal processing card, the algorithm of this embodiment is not executed. In this embodiment, in order to ensure that a packet B call can always be accommodated, the timing for executing relocation processing is when the number of vacant units becomes 0. That is to say, since the number of vacant resources that enable a packet B call to be accommodated is 16, the vacant unit number threshold value for triggering activation of relocation processing (hereinafter referred to as “unit_threshold”) is set to 1. In this embodiment, relocation processing is activated when a call accommodated in the base transceiver station is deallocated. The effect of the present invention can also be obtained if relocation processing is activated immediately after a call is allocated, or periodically.

In processing 1301, in relocation, a group of shift source candidate units is created, comprising a list of units for which there is a possibility of becoming a call shift destination. At the time of initialization, elements of this group are all units installed in all signal processing cards. In the case shown in FIG. 12, there are four cards each including two units, and therefore the number of members of the group is 4×2=8.

In processing 1302, units are searched for that are objects for creating vacant units in relocation processing. A vacant unit is created by shifting an already call accommodated to another signal processing card unit in relocation processing. In this processing, a shift source unit is selected in accordance with the following priority order, as in processing 1302.

1) In descending order starting with the greatest number of vacant resources of a unit

2) In descending order starting with the greatest total number of vacant resources in a card

3) In low-to-high card number order

4) In low-to-high unit number order

The reason for giving priority to the order of the number of vacant resources in a unit over the number of vacant resources in a card is that, with the algorithm of this embodiment, it is necessary to provide vacant units for packet B call accommodation.

In the case shown in FIG. 12, the units with the greatest number of vacant resources are second unit 1201b of first signal processing card 1106a and first unit 1203a of third signal processing card 1106c, in each of which the number of vacant resources is 11. Then, when the numbers of vacant resources of cards are compared, first signal processing card 1106a has 19 vacant resources (32 total installed resources minus 8 common channel resources, 3 unrestricted digital call resources, and 2 voice call resources), and third signal processing card 1106c has 14 vacant resources (32 total installed resources minus 9 voice call resources, 3 unrestricted digital call resources, and 6 packet A call resources)—that is, first signal processing card 1106a has fewer resources in use. Thus, in the case shown in FIG. 12, second unit 1201b of first signal processing card 1106a becomes the shift source unit.

In processing 1303, a call to be shifted is selected within the shift source unit. The number of required resources of this call is hereinafter referred to as “source_call.” The object of the processing in this embodiment is to accept a call with the greatest possible number of required resources. Therefore, a call with a large number of required resources is selected here in order to make the number of vacant resources as large as possible.

In FIG. 12, unrestricted digital call 1206 is selected, as this is the call using the greatest number of resources in second unit 1201b of first signal processing card 1106a.

In processing 1304, it is determined whether the selected call can be shifted to another signal processing card. The objects of comparison are the number of required resources of the selected call and the greatest number of vacant resources in the units installed in all the other signal processing cards. If the number of vacant resources in a signal processing card is greater than or equal to the number of required resources of the selected call (source_call≦vacancy [i] [j] holds true for either i or j (1≦i≦4, 1≦j≦2)), it is possible for the selected call to be shifted to another signal processing card, and the processing flow proceeds to processing 1305.

On the other hand, if the number of required resources of the selected call is greater, it is not possible for the selected call to be shifted to another signal processing card, and the processing flow proceeds to processing 1309.

The same kind of improvement in resource accommodation efficiency as in the present invention is also achieved in a case where, if there are vacant resources allowing accommodation in a unit of the same card to which the shift destination call belongs as the shift destination unit, a unit of the same card is selected preferentially as the shift destination.

In FIG. 12, the number of vacant resources in all units is greater than or equal to 3, and therefore the processing flow proceeds to processing 1305.

In processing 1305, the shift destination of the selected card is searched for. In order not to increase the number of vacant resources of the shift destination signal processing card as far as possible, a destination for which the number of vacant resources is close to the number of required resources of the call is selected.

In the case shown in FIG. 12, since the call to be shifted is an unrestricted digital call for which the number of required resources is 3, of all the units excluding the shift source unit, second unit 1203b of third signal processing card 1106c, whose number of vacant resources of 3 is closest to the number of required resources of selected unrestricted digital call 1206, is selected as the shift destination.

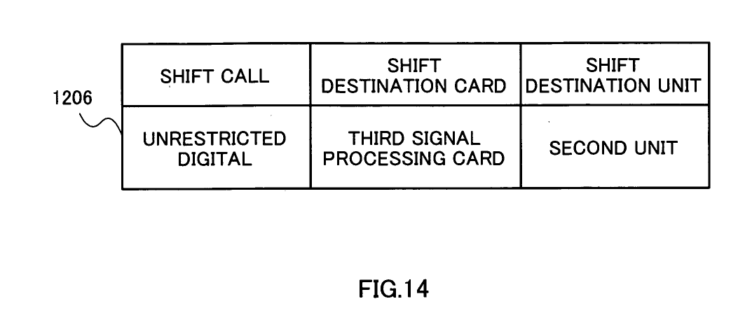

In processing 1306, the shift call and the shift destination unit are added to the list of calls whose shift destination has been determined (“shift call destination determined list”). This shift call destination determined list is shown in FIG. 14. In this embodiment, items stored in the call shift destination determined list are the call to be shifted, that is, unrestricted digital call 1206, and the signal processing card number and signal processing unit number of the shift destination.

In processing 1307, it is confirmed whether or not a number of vacant units greater than or equal to threshold value unit_threshold have been created in the selected card by relocation processing. Specifically, if the value resulting from adding the number of forthcoming vacant units to the present number of vacant units of the shift source card is greater than or equal to the threshold value, it is no longer necessary to shift more calls. Therefore, in processing 1307, it is determined whether or not the number of vacant units when a call entered in the shift call list is shifted exceeds threshold value unit_threshold.

In the case shown in FIG. 12, the number of vacant resources of second unit 1201b in first signal processing card 1106a (vacancy [1] [2]) is 11, and the number of required resources of the selected call is 3, giving a total of 14, which is less than the number of resources of one unit (16), and therefore the number of newly vacant units is 0. As the present number of vacant units is also 0, and it is not possible to secure the number of vacant units equivalent to threshold value unit_threshold (=1), the processing flow returns to processing 1304.

Calls for which resource relocation is to be performed are selected by repeating above-described processing 1303 through processing 1307. In the second-time and third-time repetitions, two voice calls in the second signal processing card are finally selected. In this case, two voice calls in second unit 1201b of first signal processing card 1106a are shifted to second unit 1202b of second signal processing card 1106b in which the number of vacant resources is smallest. As a result, all calls accommodated in first signal processing card 1106a are stored in the shift call list, and, in the determination in processing 1307, also, the total of [vacancy [1] [2]+calls on the shift call list is (voice call×2+unrestricted digital call×1=5)=11+5=16, and it is seen that this unit becomes a vacant unit. As a result of this shift, the number of vacant units becomes 1, equal to threshold value unit_threshold (=1), and therefore the processing flow proceeds to processing 1308.

In processing 1308, all the calls whose shift destination has been determined, listed in processing thus far, are shifted to their respective selected units. This completes processing relating to FIG. 12.

If, in processing 1304, the number of vacant resources in other signal processing cards is less than the number of required resources of the selected call, the selected call cannot be shifted, and therefore the shift source unit must be changed. The processing flow therefore proceeds to processing 1309.

In processing 1309, in order to change the unit subject to a shift source search, the currently selected unit is eliminated from the group of shift source candidate units.

In processing 1310, it is determined whether any units remain in the group of shift source candidate units. If units remain, the processing flow returns to processing 1302, and if no units remain, processing is terminated. If processing is terminated here, this is a case in which a call cannot be shifted and vacant resources cannot be created.

In this embodiment it has been assumed that processing capability is the same for all cards, but in a case where processing capability varies from card to card, the effect of the present invention can be similarly obtained if not only the number of vacant resources but also the number of resources installed in each card are managed.

In order to accommodate a packet A call, it is possible to make the threshold value a number of vacant resources instead of a number of vacant units.

In this case, the same kind of effect as in this embodiment can be achieved by making the following modifications.

*In processing 1303, the number of resources needed to meet the threshold value is calculated by subtracting the number of used resources of the selected unit from the threshold value. Then calls are selected so that the number of resources that are short is met or exceeded, selection is performed from those among these calls with the greatest number of used resources, and the number of shift destination resources is searched for.

*In processing 1307, the number of vacant resources is used, rather than the number of vacant units, in determining whether or not relocation is to be executed. In the case of processing 1309 onward in which a call with a large number of resources cannot be shifted after determination of operation according to the number of resources has been performed, it is possible to reduce call loss by creating a number of vacant resources corresponding to the call to be shifted in a unit other than the present shift source unit, and shifting the call that could not be shifted to that unit. Specifically, if the number of required resources of the call that could not be shifted is made a new, provisional threshold value in processing 1309 onward, and processing 1302 onward is executed, relocation is performed with the number of vacant resources as the threshold value in accordance with the above-described algorithm, and the number of vacant resources equivalent to the provisional threshold value can be created.

As described above, according to this embodiment, when a plurality of units that perform signal processing are present in a signal processing card, and call allocation that spans units cannot be performed, an effect of enabling call loss to be reduced and resource utilization to be performed efficiently can be obtained by performing relocation so that the number of used resources of a particular unit is made 0.

### Embodiment 4

A fourth embodiment of the present invention will now be described.

In this embodiment an algorithm is described that equalizes the numbers of used resources of a plurality of signal processing cards.

If the numbers of resources used by a plurality of signal processing cards are equalized taking only load distribution into consideration, call loss is prone to occur when traffic is heavy. For example, in a case such as that in Embodiment 3 in which there are four signal processing cards, and each signal processing card has two units each capable of accommodating 16 resources, if 108 voice calls are generated, 27 voice calls are allocated to each card, and thus the number of vacant resources of each card is 16×2−27=5. Therefore, although there are 16×4×2−108=20 vacant resources in total, allocation cannot be performed for a call whose number of required resources is 6 or more (a packet A call or packet B call).

Thus, in this embodiment, in addition to the processing in Embodiment 3, processing is also performed in accordance with the volume of traffic. That is to say, relocation processing is separated for cases where the volume of traffic is high (heavy traffic) and the volume of traffic is low (light traffic), and a relocation scheme that distributes vacant resources among a plurality of cards is implemented when traffic is light, while a relocation scheme that concentrates vacant resources in some units to prevent call loss is implemented when traffic is heavy.

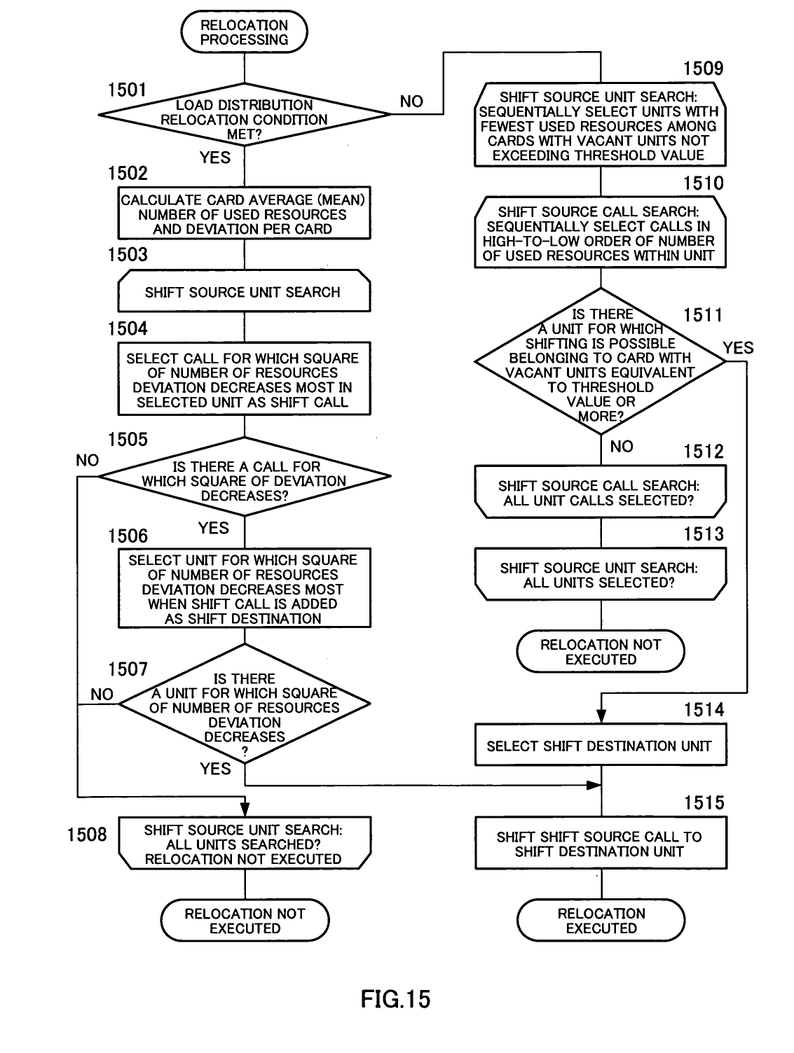

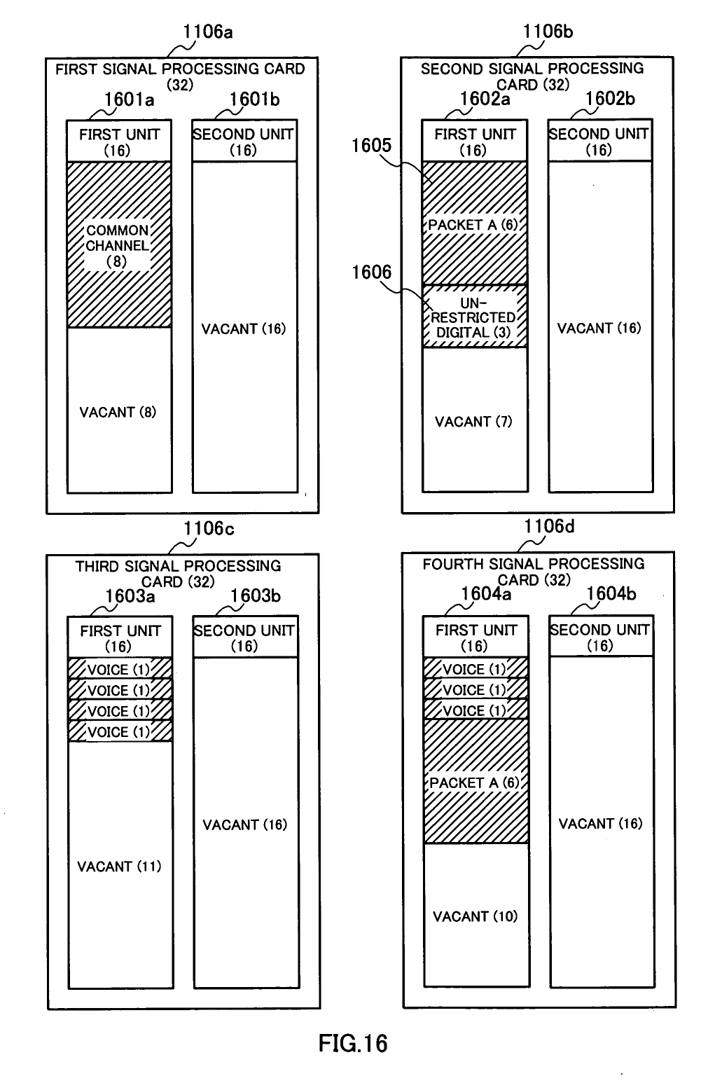

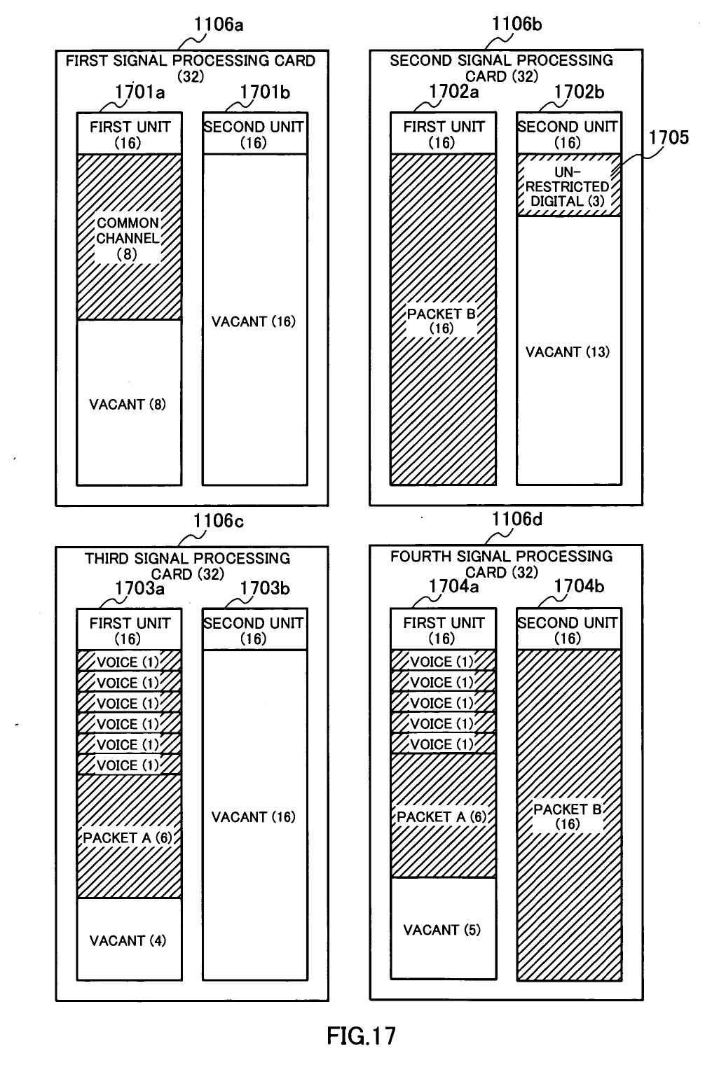

The algorithm of this embodiment will be explained below using FIG. 15, FIG. 16, and FIG. 17.

FIG. 15 is a flowchart showing the operation of the algorithm of this embodiment. FIG. 16 is a configuration diagram showing the state of signal processing cards at the time of light traffic when call volume is low and resources are vacant, and FIG. 17 is a configuration diagram showing the state of signal processing cards when call volume is higher than in FIG. 16 and traffic is comparatively heavy.

The processing in FIG. 15 is activated when a call is cleared, as in Embodiment 3. The effect of this embodiment can be obtained regardless of initiation timing, such as initiation at the time of call generation or periodic activation.

First, in processing 1501, the volume of traffic generated in the coverage area of a base transceiver station is determined. If traffic is light the processing flow proceeds to load distribution processing in processing 1502 onward, whereas if traffic is heavy the processing flow proceeds to processing to increase the maximum number of vacant resources in the base transceiver station in processing 1509 onward. As the scheme of specifically determining the volume of traffic, the number of units can be used instead of the number of resources used by all cards. In this embodiment, the threshold value is set to 1 unit so that “there is one vacant unit each in all signal processing cards,” and in the case of a value lower than this the traffic is determined to be light, and load distribution processing in processing 1502 onward is activated.

It is also possible to define the threshold value as a number of resources, as “a state in which there are a total of 64 vacant resources in all signal processing cards (Σ vacancy [i]≧64),” and the effect of the present invention can also be achieved in this case.

In the case shown in FIG. 16, there are vacant units in all the signal processing cards, and therefore this is classified as a light traffic situation. Consequently, in the case shown in FIG. 16, the processing flow proceeds to processing 1502. In the case shown in FIG. 17, on the other hand, there is no card with a vacant unit, and therefore this is classified as a heavy traffic situation, and the processing flow proceeds to processing 1509.

In this embodiment, operation in the case of light traffic will first be described. A light traffic situation corresponds to FIG. 16.

Secondly, in processing 1502, the mean number of vacant resources of all signal processing cards, and the number of vacant resources and mean difference (deviation) of each card are calculated for all cards. In the case shown in FIG. 16, the numbers of vacant resources are 24, 23, 27, and 26, respectively, for first signal processing card 1106a through fourth signal processing card 1106d, and therefore the mean number of vacant resources of each signal processing card (hereinafter referred to as “mean_vacancy”) is 25.

Meanwhile, the deviations of the number of vacant resources of each signal processing card are as follows.

First signal processing card 1106a: 24−25=−1

Second signal processing card 1106b: 23−25=−2

Third signal processing card 1106c: 27−25=2

Fourth signal processing card 1106d: 26−25=1

Thirdly, in processing 1503, in order to equalize the number of vacant resources among the signal processing cards, a card whose load is comparatively greater (whose number of vacant resources is comparatively smaller) than other signal processing cards is selected as a shift source card, and a call is shifted from the selected signal processing card to another signal processing card. Specifically, of all the signal processing cards, the signal processing card with the smallest number of vacant resources is selected. Next, the unit with the greatest number of vacant resources among units accommodating calls is selected as the shift destination. This is because shifting a call from a unit with a large number of vacant resources to another card creates a larger space, and facilitates accommodation of a call whose number of required resources is large.

In the case shown in FIG. 16, first unit 1602a is selected from second signal processing card 1106b, which has the smallest number of vacant resources. The reason for selecting first unit 1602a is that it is the only unit used by second signal processing card 1106b.

Fourthly, the shift source call is selected in processing 1504. In order to equalize the number of resources used among the cards, the number of used resources must be brought close to the mean of all the cards. Therefore, when a call is shifted to another signal processing card, the call is shifted only if the square of the deviation decreases in the shift source card. The effect is the same even if the search is limited to signal processing cards with a number of used resources not less than the mean.

In the case shown in FIG. 16, assuming that packet A call 1605 is selected to be shifted, the number of vacant resources before the shift is 23 (and the deviation is −2 (vacancy [2]−mean_vacancy=23−25=−2), and thus the square of the deviation is 4), and the number of vacant resources after the shift is 29 (and the square of the deviation is the square of (29−25), 16), meaning that the square of the deviation increases. Therefore, the packet A call cannot be selected. If unrestricted digital call 1606 is selected, the number of vacant resources after the shift is 6 (and the square of the deviation is the square of (23+3−25), 1), meaning that the square of the deviation has become the smallest. Therefore, unrestricted digital call 1606 is selected as the call to be shifted.

Fifthly, if a call to be shifted cannot be selected in processing 1505, the processing flow proceeds to processing 1508, which is the end of the loop, and another unit is searched for. If a call to be shifted can be selected, the processing flow proceeds to processing 1506.

In the case shown in FIG. 16, a call to be shifted is found, and therefore the processing flow proceeds to processing 1506.

Sixthly, a shift destination-unit is searched for in processing 1506. The unit selected as the shift destination unit has a number of used resources of one or more, and has the smallest decrease in the square of the deviation of the pre-shift and post-shift numbers of used resources.

In the case shown in FIG. 16, shift destination candidates are currently used first units 1601a, 1603a, and 1604a of first signal processing card 1106a, third signal processing card 1106c, and fourth signal processing card 1106d. Assuming that unrestricted digital call 1606 is shifted, the numbers of used resources change according to the shift destination, as follows.

(1) In first signal processing card 1106a, the number of used resources is 8 common channel resources+3 unrestricted digital call resources=11, and thus the number of vacant resources is 21 (and the square of the deviation is 16).

(2) In third signal processing card 1106c, the number of used resources is 5 common channel resources+3 unrestricted digital call resources=8, and thus the number of vacant resources is 24 (and the square of the deviation is 1).

(3) In fourth signal processing card 1106d, the number of used resources is 6 common channel resources+3 unrestricted digital call resources=9, and thus the number of vacant resources is 23 (and the square of the deviation is 4).

Thus, first unit 1603a of third signal processing card 1106c, for which the square of the deviation of the number of vacant resources is the smallest, becomes the shift destination for unrestricted digital call 1606′.

Seventhly, in processing 1507, the call shift ability is determined. If the call can be shifted, the processing flow proceeds to shift processing in processing 1515, and exits the loop. If the call cannot be shifted, processing is terminated, and the loop is continued. Specifically, a decision is made based on the presence or absence of a unit for which the square of the deviation of the number of vacant resources decreases as a shift destination.

In the case shown in FIG. 16 the call can be shifted, and therefore the processing flow proceeds to processing 1515.

Eighthly, in processing 1515 the shift source call is shifted to the shift destination unit, and relocation processing is terminated.

If call shifting is not possible in processing 1507, if units remain in processing 1508 the loop is continued, and therefore the processing flow returns to processing 1503, and if all calls that are shift source search objects have been selected the loop is terminated, and the series of resource relocation processing steps is terminated. This concludes a description of resource relocation processing when traffic is light.

Following the description of FIG. 16, processing from processing 1509 onward in the case of heavy traffic will now be described using FIG. 17.

Here, the threshold value for the number of vacant units of each signal processing card is set to 1, the same as when traffic is light. When traffic is heavy, call relocation is carried out so that each card can secure at least the threshold number of units as far as possible.

The actual resource relocation processing performed when traffic is heavy will now be described.

First, in processing 1509, a shift source unit is searched for. This search is carried out in order starting with the smallest number of used resources among cards in which there are vacant units not exceeding the threshold value.

In the case shown in FIG. 17, cards with fewer vacant units than the threshold value for the number of vacant units, 1, are second signal processing card 1106b and fourth signal processing card 1106d. Of the units in these signal processing cards, the unit with the smallest number of used resources is second unit 1702b of second signal processing card 1106b.

Secondly, in processing 1510, a loop is started for searching for a shift source call by selecting calls sequentially in high-to-low order of the number of required resources from the selected unit.

In the case shown in FIG. 17, second unit 1702b, which is the unit whose number of vacant resources is closest to the number of required resources of the selected call, is selected as the shift destination unit. As only unrestricted digital call 1705 is accommodated in second unit 1702b, this unrestricted digital call 1705 is selected as the shift source call.

Thirdly, in processing 1511, it is determined whether the shift source call can be shifted. There are two conditions for deciding whether or not it is possible to shift a selected call to another unit, as follows:

(c1) The number of vacant resources in the card to which the shift destination candidate unit belongs is greater than or equal to the mean.

(c2) The number of vacant resources in the shift destination candidate card is greater than the number of required resources of the selected call.

If shifting is possible, the processing flow proceeds to processing 1514 and exits the loop.

If shifting is not possible, the processing flow proceeds to processing 1512 and the loop is continued.

In the case shown in FIG. 17, unrestricted digital call 1705 can be shifted to any other signal processing card, and therefore the processing flow proceeds to processing 1514.

Fourthly, the shift destination unit is selected in processing 1514.

In processing 1514, in order to leave the largest possible space and enable a call whose number of required resources is large to be accommodated, a unit for which the number of vacant resources and the number of required resources of the selected call are closest is selected as the shift destination unit from among the units that are shift destination candidates.

In the case shown in FIG. 17, there are three candidates for the shift destination of an unrestricted digital call: first signal processing card 1106a, third signal processing card 1106c, and fourth signal processing card 1106d. As the numbers of vacant resources in the first units of these cards are 8, 4, and 5, respectively, first unit 1703a of third signal processing card 1106c whose number of vacant resources is closest to the number of used resources (3) of unrestricted digital call 1705 is selected as the shift destination unit.

Fifthly, in processing 1515, the shift source call is shifted to the shift destination unit.

In the case shown in FIG. 17, unrestricted digital call 1705 is shifted to first unit 1703a of third signal processing card 1106c.

In a case where the number of vacant resources is 0, for instance, it continues to be determined in processing 1511 that there is no unit for which shifting is possible, the processing 152 and processing 1513 loops end, and the series of processing steps ends without relocation being executed.

In this embodiment, a condition when selecting a shift source call and shift destination unit has been assumed to be that the square of the deviation of the number of used resources decreases in both units, but the same kind of effect as in this embodiment can also be obtained using the following methods.

(a) A method whereby dispersion or standard deviation of all cards before shifting and after shifting is calculated for combinations of all currently accommodated calls and their designated units, and call shifting is performed by selecting the combination of shift source call and shift destination unit for which dispersion decreases most.

(b) A method whereby an increase/decrease in the deviation of a unit before shifting and an increase/decrease in the deviation of a shift destination unit are calculated both before shifting and after shifting, and shifting of a call of a combination for which deviation is smallest after shifting is performed.

Method (a) is the more reliable, but since there may be a plurality of candidate shift destinations for all calls accommodated in a base transceiver station, if dispersion is calculated for all combinations of shift source call and shift destination unit, the calculation load on the radio resource control section that determines the relocation destination is great, and it is therefore difficult to use this method in a base transceiver station in which many calls may be generated in one second and these must be processed in a short time. Also, stringent load distribution among cards in a base transceiver station is not necessarily required. The kind of simple processing used in this embodiment is sufficient.

As described above, according to this embodiment, by determining the volume of traffic, performing location so as to distribute the load by equalizing the number of resources of each card when traffic is light, and performing relocation so as to acquire a large number of vacant resources and enable a call whose number of required resources is large to be accommodated by packing resources into units to the greatest extent possible when traffic is heavy, an effect can be obtained of enabling load distribution among cards when traffic is light while preventing the occurrence of call loss as far as possible.

As described above, the present invention enables call loss to be reduced and signal processing card capabilities to be utilized more efficiently by determining a threshold value based on units used by accommodated calls after resource allocation, and relocating resources so as to create vacant units equivalent to the threshold value when vacant units equivalent to the threshold value are no longer present in any signal processing card.

After resources have been allocated, a threshold value for the number of vacant units is determined on a unit-by-unit basis in order to distinguish between heavy and light traffic, and by performing relocation so that when the number of vacant units is less than the threshold value a call requiring a large number of resources can be accommodated in one card since traffic is heavy, and when traffic is light the number of resources used by the signal processing cards is equalized, it is possible to more effectively avoid call loss that cannot be improved simply with a method of distributed resource location at the time of allocation.

Also, according to the present invention, an effect can be obtained of accommodating a new call without disconnecting an existing call, reducing call loss, and increasing the accommodation capability of a base transceiver station, by providing a traffic recording section; providing a radio resource control section wherein, based on data stored in the traffic recording section, a resource monitoring section dynamically rewrites a threshold value that is a condition for activating resource relocation processing, and performs relocation repeatedly until the threshold value is reached; and providing a radio resource monitoring section that monitors the maximum size of vacant resources, and activates the radio resource control section when this size is less than or equal to the threshold value.

Furthermore, according to the present invention, by providing a base transceiver station resource monitoring section and a base transceiver station resource control section in a radio network controller, and performing resource relocation among a plurality of base transceiver stations whose coverage areas overlap, it is possible to prevent base transceiver station load distribution and loss of calls from terminals, and improve resource utilization.

Moreover, the present invention is a base transceiver station resource allocation method of allocating a plurality of types of calls with differing numbers of resources relating to radio communication to a plurality of signal processing cards; wherein the type and number of calls generated in each time period are recorded, a number of resources threshold value of each time period is determined based on the type of call for which the percentage of generation is highest for that time period; and processing that relocates calls accommodated in the plurality of processing cards is performed based on the threshold value. By this means, resource relocation can be performed based on resource location and time.

Also, when it is determined that call relocation is necessary based on the threshold value, a shift source card is selected for which a number of vacant resources greater than or equal to the threshold value are secured by shifting an already accommodated call to another signal processing card; it is determined whether or not there is an accommodation destination in another signal processing card among calls already accommodated in the shift source card; and if there is an accommodation destination in another processing card, first relocation processing that relocates a first shift call that is a call to be shifted to a shift destination card that is an accommodation destination is repeated until a number of vacant resources greater than or equal to the threshold value are secured in the shift source card; and if there is no accommodation destination in another processing card, in order to accommodate a shift call accommodated in the shift source card, second relocation processing that relocates a shift call accommodated in other than the shift source card as a second shift call is repeated until it is made possible to shift a shift call accommodated in the shift source card; whereby an effect can be obtained of accommodating a new call without disconnecting an existing call, reducing call loss, and enabling the accommodation capability of a base transceiver station to be utilized to the maximum.

Furthermore, according to the present invention, when it is determined that call relocation is necessary based on the threshold value, a shift source card is selected for which a number of vacant resources greater than or equal to the threshold value are secured by shifting an already accommodated call; it is determined whether or not there is an accommodation destination in another signal processing card among calls already accommodated in the shift source card; and if there is an accommodation destination in another processing card, a shift call that is a call to be shifted and a shift destination card that is an accommodation destination are registered in a shift call list, and the number of required resources in the shift call list and the deficient number of resources lacking with respect to the number of resources of the threshold value in the shift source card are compared in size; and if the number of required resources is greater than or equal to the deficient number of resources all the shift calls are shifted and processing is terminated; whereas if the number of required resources is less than the deficient number of resources, processing that determines a shift call and shift destination card is executed again; and if there is no accommodation destination in another processing card, a shift candidate card combination with at least the deficient number of resources is selected from cards other than the shift source card, and one shift call is selected from the shift candidate calls; and when relocation processing is performed a processing card for which a vacancy can be created by relocation processing is added to the shift call list; and when relocation processing has ended for all shift candidate calls, all the shift calls in the shift call list are shifted and processing is terminated; whereby an effect can be obtained of accommodating a new call without disconnecting an existing call, reducing call loss, and enabling the accommodation capability of a base transceiver station to be utilized to the maximum.

Moreover, by performing resource relocation among a plurality of base transceiver stations whose coverage areas overlap by performing relocation processing by monitoring the coverage areas of a plurality of base transceiver stations and deciding a shift call and shift destination card among two or more base transceiver stations whose coverage areas overlap, it is possible to prevent base transceiver station load distribution and loss of calls from terminals, and improve resource utilization.

Also, the present invention is a base transceiver station that accommodates a plurality of types of calls in a plurality of signal processing cards, and is equipped with: a traffic recording section that records the type and number of calls generated in each time period; a radio resource monitoring section that, based on a number of resources of a type of call whose percentage of generation is highest for each said time period recorded in said traffic recording section, determines a threshold value of that time period; and a radio resource control section that performs relocation processing control for a call of the signal processing card based on the threshold value. By this means, a base transceiver station is provided in which resource relocation can be performed in accordance with resource location and time.

Furthermore, the radio resource control section has a management table that manages a shift call shifted by relocation and a shift destination card that accommodates the shifted call; and in the management table is recorded a list of combinations of a shift call and shift destination card corresponding to relocation processing for securing a number of resources equivalent to the threshold value; whereby a base transceiver station can be provided that enables a new call to be accommodated without disconnecting an existing call, call loss to be reduced, and the accommodation capability of a base transceiver station to be utilized to the maximum.

Moreover, the present invention is a radio network controller that is equipped with: a base transceiver station resource management section that manages the resources of a plurality of base transceiver stations for which relocation is performed based on a threshold value in accordance with traffic recording; a communication section that communicates with the plurality of base transceiver stations; and a base transceiver station resource control section that causes relocation processing to be performed among base transceiver stations whose coverage areas overlap based on the threshold value. By this means, a radio network controller can be provided that can perform resource relocation and effectively utilize the resources of base transceiver stations whose coverage areas overlap.

Also, according to the present invention, after resources have been allocated, a threshold value is determined for each unit used by a call that is wished to be accommodated, and when there is no longer a number of vacant units equivalent to the threshold value in any signal processing card, resources are relocated so as to create vacant units equivalent to the threshold value, thereby reducing call loss and utilizing the capabilities of the signal processing cards effectively.

Furthermore, to solve the above-described problems, according to the present invention, after resources have been allocated, a threshold value for the number of vacant units (a vacant unit being a unit for which the number of used resources is 0, this definition also applying hereinafter) in order to distinguish between heavy and light traffic is determined on a unit-by-unit basis, and by performing relocation so that when the number of vacant units is less than the threshold value a call requiring a large number of resources can be accommodated in one card since traffic is heavy, and when traffic is light the number of resources used by the signal processing cards is equalized, it is possible to avoid call loss that cannot be improved simply with a method of distributed resource location at the time of allocation.

This application is based on Japanese Patent Application No. 2003-135818 filed on May 14, 2003, and Japanese Patent Application No. 2003-184160 filed on Jun. 27, 2003, the entire content of which is expressly incorporated by reference herein.

### INDUSTRIAL APPLICABILITY

The present invention is applicable to a resource management method whereby, in a radio network apparatus that accommodates terminals that perform radio communication, resources in the apparatus are allocated appropriately to each terminal

1. A resource relocation method in a base transceiver station that allocates a plurality of types of calls with different numbers of resources to a plurality of signal processing cards, comprising:
setting a threshold value relating to a number of vacant resources of each of said plurality of signal processing cards as corresponding to each of a plurality of predetermined time periods; and
performing relocation processing for a call already accommodated in said plurality of signal processing cards when a number of vacant resources in a predetermined number of signal processing cards among said plurality of signal processing cards becomes less than or equal to respective said threshold value.

2. The resource relocation method according to claim 1, wherein, in said relocation processing:
a shift source card that secures a number of vacant resources greater than or equal to said threshold value is selected from among said plurality of signal processing cards;
a call already accommodated in a selected shift source card is shifted to another signal processing card among said plurality of signal processing cards; and
if said other signal processing card is unable to accommodate a call accommodated in said shift source card, relocation processing is performed for a call already accommodated in said other signal processing card.

3. The resource relocation method according to claim 1, wherein, in said relocation processing:
a shift source card that secures a number of vacant resources greater than or equal to said threshold value is selected from among said plurality of signal processing cards;
a deficient number of vacant resources of a selected shift source card is calculated;
one or more calls for which a total number of resources is greater than or equal to a deficient number of vacant resources are selected from among calls already accommodated in said shift source card, and a shift destination card corresponding to each selected call is searched for among said plurality of signal processing cards; and
all selected calls are shifted to respective corresponding shift destination cards.

4. The resource relocation method according to claim 1, wherein coverage areas of a plurality of base transceiver stations are monitored, and relocation is performed by determining a shift call and shift destination card among two or more base transceiver stations whose said coverage areas overlap.

5. A base transceiver station that allocates a plurality of types of calls with different numbers of resources to a plurality of signal processing cards, said base transceiver station comprising:
a monitoring section that, sets a threshold value relating to a number of vacant resources of each of said plurality of signal processing cards as corresponding to each of a Plurality of predetermined time periods; and
a control section that, when a number of vacant resources in a predetermined number of signal processing cards among said plurality of signal processing cards becomes less than or equal to respective said threshold value, performs relocation processing for a call already accommodated in said plurality of signal processing cards.

6. The base transceiver station according to claim 5, wherein:
said control section comprises a management table that manages a shift call shifted by relocation and a shift destination card that accommodates said shifted call; and
in said management table is recorded a list of combinations of said shift call and said shift destination card corresponding to relocation processing for securing a number of resources equivalent to said threshold value.

7. A radio network controller comprising:
a management section that manages resources of a plurality of base transceiver stations according to claim 5; a communication section that communicates with said plurality of base transceiver stations; and
a base transceiver station resource control section that causes relocation processing based on said threshold value to be performed among base transceiver stations whose coverage areas overlap among said plurality of base transceiver stations.

8. The resource relocation method according to claim 1, wherein said threshold value is set based on a number of resources of a call accommodated preferentially in each time period.

9. The resource relocation method according to claim 8, wherein a number of resources of a call that has the greatest generation percentage in each time period is used as a number of resources of a call accommodated preferentially in each time period.

10. The base transceiver station according to claim 5, wherein said monitoring section sets said threshold value based on a number of resources of a call accommodated preferentially in each time period.

11. The base transceiver station according to claim 10, wherein said monitoring section uses a number of resources of a call that has the greatest generation percentage in each time period as a number of resources of a call accommodated preferentially in each time period.
